(19) United States
(12) Patent Application Publication
(10) Pub. No.: US 2026/0233206 A1
(43) Pub. Date: Aug. 13, 2026

(54) CATALYST COMPOSITION, EXHAUST GAS TREATMENT METHOD USING THE SAME, AND EXHAUST GAS TREATMENT SYSTEM INCLUDING THE SAME

(71) Applicants: Samsung Electronics Co., Ltd., Suwon-si (KR); Gwangju Institute of Science and Technology, Gwangju (KR)

(72) Inventors: Dongjin Ham, Suwon-si (KR); Sung Bong Kang, Gwangju (KR); Sang Woo Byun, Gwangju (KR); Hyeonwoo Shin, Gwangju (KR); Min Seok Koo, Suwon-si (KR); Hyukjae Kwon, Suwon-si (KR); Jaiyoung Chung, Suwon-si (KR); Jonghyun Ha, Suwon-si (KR); Hyeonsu Heo, Suwon-si (KR); Kyeongmin Baek, Suwon-si (KR); Seunghee Son, Suwon-si (KR); Wonseok Choi, Gwangju (KR)

(21) Appl. No.: 19/440,892

(22) Filed: Jan. 6, 2026

(30) Foreign Application Priority Data
Feb. 13, 2025 (KR) 10-2025-0018787

(51) Int. Cl. B01J 23/89; B01D 53/86; B01D 53/94; B01J 21/04; B01J 35/30; B01J 35/40; B01J 35/57; B01J 37/02; B01J 37/08; F01N 3/035; F01N 3/10; F01N 3/28; F01N 13/00

(52) U.S. Cl. CPC B01J 23/8913; B01D 53/8628; B01D 53/9418; B01D 53/9477; B01J 21/04; B01J 35/394; B01J 35/397; B01J 35/40; B01J 35/57; B01J 37/0201; B01J 37/08; F01N 3/035; F01N 3/106; F01N 3/2803; F01N 13/009; B01D 2251/21; B01D 2255/104; B01D 2255/20746; B01D 2255/9155; B01D 2257/404; B01D 2258/012; B01D 2258/0216; F01N 2370/04; F01N 2610/1453

(57) ABSTRACT

A selective catalytic reduction catalyst composition for treating exhaust gas containing nitrogen oxides, an exhaust gas treatment method using the catalyst composition, and an exhaust gas treatment system including the catalyst composition. The catalyst composition includes a first catalyst including a silver oxide represented by AgₘOₓ wherein m=1 or m=2, and 0.5≤x≤5, silver metal represented by Ag, or a combination thereof. A second catalyst includes a metal oxide represented by MₐO_{b} wherein 1≤a≤5, and 1≤b≤5, a metal represented by M, and a combination thereof, where M is an element other than silver, belonging to Groups 3 to 14 and 16 of the Periodic Table of Elements; and a support.

### CROSS-REFERENCE TO RELATED APPLICATION

This application is based on and claims priority to Korean Patent Application No. 10-2025-0018787, filed on Feb. 13, 2025, in the Korean Intellectual Property Office, and all the benefits accruing therefrom under 35 U.S.C. § 119, the content of which is incorporated by reference herein in its entirety.

### BACKGROUND

### 1. Field

The disclosure relates to a catalyst composition, an exhaust gas treatment method using the catalyst composition, and an exhaust gas treatment system including the catalyst composition.

2. Description of the Related Art Nitrogen oxides (NOx) are one of the causes of air pollution. In order to reduce air pollution, various methods of treating exhaust gases containing nitrogen oxides are used.

A non-selective reduction process is used in which carbon monoxide, hydrogen or hydrocarbons are used as a reducing agent. Alternatively, a selective reduction process is used in which ammonia is used as a reducing agent.

### SUMMARY

Catalysts used in non-selective reduction processes have low conversion rates, and can be easily degraded by oxidation of carbon monoxide. In selective reduction processes in which ammonia is used as a reducing agent, excessive ammonia, and high operating temperatures are needed.

A method capable of effectively removing nitrogen oxides at a relatively low operating temperature and a low moisture content without using ammonia is of interest.

Provided is a selective catalytic reduction (SCR) catalyst composition having a high nitrogen oxide removal efficiency at a relatively low operating temperature and a low moisture content.

Provided is a catalyst article including the catalyst composition.

Provided is a method of treating exhaust gas using the catalyst com position.

Provided is a system for treating exhaust gas using the catalyst composition.

Additional aspects will be set forth in part in the description which follows and, in part, will be apparent from the description, or may be learned by practice of the presented embodiments of the disclosure.

According to an aspect, a selective catalytic reduction (SCR) catalyst composition for treating exhaust gas containing nitrogen oxides (NOx) includes
a first catalyst including a silver oxide represented by AgₘOₓ wherein m=1 or m=2, 0.5≤x≤5, silver metal represented by Ag, or a combination thereof,
a second catalyst including a metal oxide represented by MₐO_{b} wherein 1≤a≤5, 1≤b≤5), a metal represented by M, and a combination thereof, and
a support,
wherein M is an element other than silver belonging to Groups 3 to 14 and 16 of the Periodic Table of Elements.

According to another aspect,
a method of treating exhaust gas containing nitrogen oxides (NOₓ) includes contacting the exhaust gas with an alcoholic reducing agent in the presence of the catalyst composition.

According to another aspect,
a system for treating exhaust gas containing nitrogen oxides (NOₓ) includes
a catalyst article located downstream from an emission source emitting the exhaust gas in fluid communication with the emission source,
wherein the catalyst article includes the catalyst composition.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a graph showing intensity (arbitrary unit, a.u.) versus 2 theta (degree) of the x-ray diffraction (XRD) spectra of catalyst compositions prepared in Examples 1 to 3;

FIG. 2 illustrates a graph showing the results of H₂-TPR (temperature programmed reduction) measurements for catalyst compositions prepared in Example 2, Comparative Example 1, and Comparative Example 2;

FIG. 3 illustrates a graph showing the results of measuring catalytic activity according to temperature for catalyst compositions of Examples 2 and 3 and Comparative Example 1;

FIG. 4 illustrates a graph showing the results of measuring catalytic activity according to moisture content for a catalyst composition of Example 2;

FIG. 5 illustrates a graph showing the results of measuring catalytic activity according to moisture content for a catalyst composition of Comparative Example 1;

FIG. 6 is a graph illustrating the isopropanol (IPA) adsorption characteristics of a catalyst composition of Comparative Example 1 when moisture is supplied and when moisture is not supplied;

FIG. 7 is a graph illustrating the isopropanol (IPA) adsorption characteristics of a catalyst composition of Example 2 when moisture is supplied and when moisture is not supplied;

FIG. 8 is a schematic view of a catalyst filter according to an embodiment;

FIG. 9 is a schematic view of a catalyst filter according to another embodiment;

FIG. 10 is a cross-sectional view of the catalyst filter taken along the vertical (Z axis) line in FIG. 8;

FIG. 11 is a schematic view of a catalyst filter according to another embodiment;

FIG. 12 is a front view of an inflow surface of untreated exhaust gas of the catalyst filter of FIG. 11;

FIG. 13 is a front view of an outflow surface of untreated exhaust gas of the catalyst filter of FIG. 11;

FIG. 14 is a cross-sectional view of the catalyst filter taken along the line 4-4′ of FIG. 12; and

FIG. 15 is an enlarged view of a first portion A1 of a horizontal area of FIG. 14.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

The present inventive concept to be described below may undergo various modifications and have various embodiments, and specific embodiments will be illustrated in the drawings and described in detail in the detailed description. However, this is not intended to limit the present inventive concept to a specific embodiment, but should be understood to include all modifications, equivalents or substitutes included in the technical scope of the present inventive concept.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers, and/or sections should not be limited by these terms. These terms are only used to distinguish one element, component, region, layer or section from another element, component, region, layer, or section.

Thus, “a first element,” “component,” “region,” “layer,” or “section” discussed below could be termed a second element, component, region, layer, or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. Therefore, reference to “an” element in a claim followed by reference to “the” element is inclusive of one element as well as a plurality of the elements.

It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

The terms to be used below are used only to describe specific embodiments and are not intended to limit the present inventive concept. Singular expressions include plural expressions unless the context clearly indicates otherwise. Hereinafter, the terms “include” or “have” and the like are intended to indicate the presence of a feature, number, step, operation, component, part, ingredient, material, or combination thereof described in the specification, but should be understood to not exclude in advance the possibility of the presence or addition of one or more other features, numbers, steps, operations, components, parts, ingredients, materials, or combinations thereof. The “/” to be used below may be interpreted as either “and” or “or” depending on the situation.

To clearly express the various layers and regions in the drawings, the thickness is enlarged or reduced. Similar parts are designated by the same reference numerals throughout the specification. When a part, such as a layer, film, region, or plate, is said to be “on” or “over” another part throughout the specification, this case includes not only a case where it is directly on the other part, but also a case where there are other parts therebetween. Throughout the specification, the terms first, second, etc. may be used to describe various components, but the components should not be limited by the terms. The terms are used only to distinguish one component from other components. In this specification and drawings, components having substantially the same functional configuration are referred to by the same reference numerals, and redundant descriptions are omitted.

Unless otherwise indicated herein, all parts and percentages are by weight. The “weight percentage (wt %)” is based on a total composition free of volatile matter, that is, a dry solid content, unless otherwise indicated.

As used herein, the “substantially free” means “almost or completely free” or “not intentionally added at all.” Also, the “substantially free” means having only a trace amount and/or an unintended amount. For example, the “substantially free” means less than 2 wt%, less than 1.5 wt %, less than 1.0 wt %, less than 0.5 wt %, 0.25 wt %, or less than 0.01 wt %, based on the total weight of a composition.

As used herein, the “Group” refers to a group in The Periodic Table of the elements according to the International Union of Pure and Applied Chemistry (“IUPAC”) Group 1-18 classification system.

As used herein, the “particle diameter” refers to an average diameter when a particle is spherical, and refers to an average major axis length when the particle is non-spherical. The particle diameter may be measured using a particle size analyzer (PSA). The “particle diameter” is, for example, an average particle diameter. The “particle diameter” is, for example, a median particle diameter, D50. Alternatively, the “particle diameter” may be measured from scanning electron microscope images or transmission electron microscope images. The particle diameter may be a particle diameter of a single particle or an arithmetic average of particle diameters of a plurality of particles, measured manually or by software from a scanning electron microscope image.

D50 is a size of the particle corresponding to 50% of the cumulative volume, calculated from the side of the particle with the smaller particle size in the size distribution of the particles measured by laser diffraction.

D90 is a size of the particle corresponding to 90% of the cumulative volume, calculated from the side of the particle with the smaller particle size in the size distribution of the particles measured by laser diffraction.

D10 is a size of the particle corresponding to 10% of the cumulative volume, calculated from the side of the particle with the smaller particle size in the size distribution of the particles measured by laser diffraction.

As used herein, the “treatment” refers to a decrease in the amount of a target, for example, nitrogen oxides (NOₓ), caused by any means. The “treatment” refers to, for example, “abatement” or “removal.” As used herein, the “catalyst” refers to a material that promotes a chemical reaction.

As used herein, the “catalyst composition”, also referred to as “catalytic composition” refers to a composition including a plurality of catalysts or a composition including one or more catalysts and a support.

As used herein, the “metal” includes both metals and metalloids such as silicon, germanium, and selenium, in an elemental or ionic state.

As used herein, the “exhaust gas” or “exhaust gas stream” refer to one gas flow or a combination of more than one gas flows that may contain a liquid droplet or solid particulate matter. The exhaust gas or exhaust gas stream contains gaseous components, and is, for example, exhaust gas or exhaust gas stream of industrial plants and/or internal combustion engines. The exhaust gas or exhaust gas stream may contain certain non-gaseous components, such as liquid droplets, solid particulates, etc. The exhaust gases or exhaust gas streams of industrial plants and/or internal combustion engines may contain, for example, nitrogen oxides (NOₓ). The exhaust gases or exhaust gas streams of industrial plants and/or internal combustion engines may additionally contain, for example, alcohol, moisture, combustion products (CO₂ and H₂O), products of incomplete combustion (carbon monoxide (CO) and hydrocarbons (HC)), combustible and/or carbonaceous particulate matter (soot), and unreacted oxygen and nitrogen.

As used herein, the “selective catalytic reduction (SCR)” process is a process that utilizes catalytic reduction of nitrogen oxides (NOₓ) and a reducing agent in the presence of a catalyst composition, and is a process in which nitrogen is mainly formed by such catalytic reduction.

As used herein, the “support” refers to a material used as a catalyst composition in combination with one or more catalysts in particulate form.

As used herein, “supported” refers to “dispersed on,” “incorporated into,” “impregnated into,” “on,” “within,” “deposited on,” or embodiments related thereto otherwise.

As used herein, “impregnated” or “impregnation” refers to penetration of a catalytic material into a porous structure of a support material.

As used herein, the “molecular sieve” refers to an example of a porous support, and the “porous support” refers to an example of a support.

As used herein, the “molecular sieve” refers to a framework material that can be used as a catalyst composition in combination with one or more catalysts in particulate form. The molecular sieve includes, for example, active carbon, alumina, titania, silica, zirconia, zeolites, and other framework materials (e.g., isomorphously substituted materials). The molecular sieve includes, for example, porous carbon such as active carbon. The molecular sieve includes porous metal oxides such as alumina, titania, silica, zirconia, and zeolites.

As used herein, “alumina”, “titania”, “silica”, and “zirconia” refer to examples of metal oxide-containing molecular sieves. The metal oxide-containing molecular sieve is a material based on an extensive three-dimensional network with substantially uniform or non-uniform pore distributions and an average pore size of about 20 angstroms (Å) or less. The metal oxide-containing molecular sieve contains voids formed by a rigid network of unit structures including metal and oxygen. The entrance of the void may be formed by, for example, a ring of 6 to 12 atoms with respect to the atoms forming an entrance opening. The metal oxide-containing molecular sieve is a crystalline or amorphous material having uniform or non-uniform pore sizes ranging from about 1 Å to about 1000 Å in diameter, depending on the type of molecular sieve and the type and amount of cations contained in a molecular sieve lattice.

As used herein, the “zeolite” refers to an example of the metal oxide-containing molecular sieve. The zeolite is a material based on an extensive three-dimensional network of oxygen ions having an average pore size of about 20 Å or less, generally containing tetrahedral type sites. and having a substantially uniform pore distribution. Zeolites may be distinguished primarily by the geometry of their voids formed by a rigid network of SiO₄/AIO₄ tetrahedra. The entrance of the void may be formed by, for example, a ring of 6, 8, 10, or 12 12 atoms with respect to the atoms forming an entrance opening. The zeolite is a crystalline material having uniform pore sizes ranging from about 3 Å to about 10 Å in diameter, depending on the type of zeolite and the type and amount of cations contained in a zeolite lattice. The zeolite is defined as aluminosilicate having an open three-dimensional framework structure composed of corner-sharing TO₄ tetrahedra, where T is, for example, Al or Si. As used herein, the “aluminosilicate zeolite” may include phosphorus or other metals isomorphously substituted in the framework. The “aluminosilicate zeolite” may include aluminophosphate materials, such as SAPO, AIPO and MeA1PO materials. The “zeolite” includes aluminosilicate and aluminophosphate. The zeolites may include SiO₄/AIO₄ tetrahedra linked by common oxygen atoms forming a three-dimensional network. The cations that maintain the charge balance of an anionic framework are loosely associated with framework oxygen atoms, and the remaining pore volume is filled with water molecules. Non-framework cations are generally exchangeable, and water molecules are removable. A wide variety of cations can occupy these pores and move through these channels.

As used herein, the “BET surface area” refers to a specific surface area measured by the Brunauer, Emmett, Teller method for determining surface area by nitrogen (N₂) adsorption. BET surface area, pore diameter and pore volume may be measured using BET-type nitrogen adsorption or nitrogen desorption experiments.

As used herein, the “catalytic article” or “catalyst article” refers to a component used to promote a desired reaction.

As used herein, the “substrate” refers to a base material, for example, a base material on which a catalyst composition is applied in the form of a coating film. The substrate is, for example, a monolithic material.

As used herein, the “monolithic substrate” refers to a substrate having a unitary structure that is uniform and continuous from the inlet to the outlet.

As used herein, the “wall-flow substrate” refers to a substrate including alternating inlet channels and outlet channels, wherein the inlet channels are blocked at their outlet ends and the outlet channels are blocked at their inlet ends. The exhaust gas stream entering the inlet channels is forced to pass through a filter wall before exiting the outlet channels.

As used herein, the “upstream” and “downstream” refer to a relative direction of flow of exhaust gas in an exhaust line. For example, industrial plants and/or internal combustion engines are located upstream, and filters and catalysts are located downstream of the industrial plants and/or the internal combustion engines. The inlet end of a substrate is synonymous with an “upstream” end or a “front” end. The outlet end of a substrate is synonymous with an “downstream” end or a “rear” end. The upstream region is upstream of a downstream region. The upstream region may be closer to the industrial plant and/or the internal combustion engine, and the downstream region may be further away from the industrial plant and/or the internal combustion engine.

As used herein, the “in fluid communication” is used to refer to articles located in the same exhaust line. For example, a common exhaust stream passes through articles that are in fluid communication with each other. Articles in fluid communication may be adjacent to each other in an exhaust line. Alternatively, articles in fluid communication may be separated by one or more articles, also referred to as “wall-fluid substrates”.

As used herein, the “catalyzed soot filter” refers to a wall-flow monolithic catalyzed soot filter (CSF). The catalyzed soot filter can perform soot filtration and soot regeneration functions. Additionally, the catalyzed soot filter can contain an oxidation catalyst to oxidize carbon monoxide (CO) and hydrocarbons (HC) to CO₂ and H₂O, to oxidize NO to NO₂ to accelerate downstream selective catalytic reduction (SCR) catalysis, or to promote oxidation of soot particles at lower temperatures.

Hereinafter, a catalyst composition according to embodiments, an exhaust gas treatment method using the same, and an exhaust gas treatment system including the same will be described in more detail.

### Catalyst Composition

A catalyst composition according to an embodiment is a selective catalytic reduction (SCR) catalyst composition that treats exhaust gas containing nitrogen oxides (NOₓ). The catalyst composition includes a first catalyst including one or more silver oxides represented by AgₘOₓ (wherein m=1 or m=2, 0.5≤x≤5), a metal represented by Ag, or a combination thereof; a second catalyst including a metal oxide represented by MₐO_{b} (1≤a≤5, 1≤b≤5), a metal represented by M, or a combination thereof; and a support. M in the metal oxide is an element other than silver belonging to Groups 3 to 14 and 16 of the Periodic Table of Elements. In the catalyst composition, the first catalyst and the second catalyst may be supported on, for example, the support.

Since the catalyst composition includes the first catalyst, the second catalyst, and the support, the catalyst composition can provide high catalytic activity, such as high nitrogen oxide removal efficiency and nitrogen oxide conversion rate, in a selective catalytic reduction (SCR) process for treating exhaust gas containing nitrogen oxides (NOₓ). Since the catalyst composition includes the first catalyst, the second catalyst, and the support, the catalyst composition can provide a high nitrogen oxide removal efficiency at low operation temperatures. Since the catalyst composition includes the first catalyst, the second catalyst, and the support, the catalyst composition can provide an improved nitrogen oxide removal efficiency at low moisture contents. The catalyst composition can more effectively remove nitrogen oxides included in exhaust gas.

The catalyst composition includes a first catalyst.

The first catalyst includes a silver oxide. Silver oxide can activate nitrogen oxides (NOₓ). Silver oxide can convert nitrogen oxides, such as NO, into activated nitrogen oxides, such as NO₂ and NO₃. Activated nitrogen oxides can be converted to nitrogen by an additional reaction with an activated reducing agent. The first catalyst may include one silver oxide. Alternatively, the first catalyst may include a plurality of silver oxides having different compositions from each other. The first catalyst may include, for example, one, two or more of Ag₂O, AgO, Ag₂O₃, AgO_{y} (0.5<y<1), AgO_{z} (1<z<1.5), AgO_{w} (1.5<w≤5), or a combination thereof. When the first catalyst includes silver oxides of various compositions, nitrogen oxides of various compositions can be treated more effectively.

The first catalyst includes a plurality of silver oxides having different compositions from each other, and the content (amount) of Ag₂O among the silver oxides having different compositions may be the maximum. The content of Ag₂O may be 30 wt % or more, 40 wt % or more, 50 wt % or more, 60 wt % or more, 70 wt % or more, 80 wt % or more, 90 wt % or more, 95 wt% or more, or 99 wt% or more with respect to the total weight of the first catalyst. The content of Ag₂O may be 100 wt % or less, 99 wt % or less, 95 wt % or less, or 90 wt % or less with respect to the total weight of the first catalyst. Since the content of Ag₂O among the silver oxides is the maximum, the catalyst composition can provide an improved nitrogen oxide conversion rate.

The first catalyst may further include silver (Ag) metal in addition to silver oxide. Alternatively, the first catalyst may include silver oxide, but not silver metal. The composition of silver oxides may be determined by x-ray photoelectron spectroscopy (XPS), x-ray diffraction (XRD), etc.

In an embodiment, the first catalyst includes silver metal represented by Ag. Silver metal can activate nitrogen oxides (NOₓ). Silver metal can convert nitrogen oxides such as NO into activated nitrogen oxides such as NO₂ and NO₃. Activated nitrogen oxides can be converted to nitrogen, by an additional reaction with an activated reducing agent.

In an embodiment, the first catalyst includes a combination of silver oxide and silver metal. Since the first catalyst includes a combination of silver oxide and silver metal, nitrogen oxides (NOₓ) can be more effectively activated. The combination of silver oxide and silver metal may include, for example, a mixture thereof, a composite thereof, etc.

The first catalyst may include, for example, a mixture of silver metal and silver oxide, a composite of silver metal and silver oxide, or a combination thereof. The mixture of silver metal and silver oxide may include a mixture of Ag and AgOₓ (0.5≤x≤5). The composite of silver metal and silver oxide may include a core-shell composite. The core of the core-shell composite may include Ag, and the shell of the core-shell composite may include AgOₓ (0.5≤x≤5).

The first catalyst may include, for example, a crystalline silver oxide. Since the first catalyst includes a crystalline silver oxide, the catalyst composition can provide an improved nitrogen oxide conversion rate. The crystallinity of the first catalyst may be determined, for example, by XRD, transmission electron microscopy (TEM), etc.

The catalyst composition includes a second catalyst. The second catalyst includes a metal distinct from the metal in the first catalyst.

The second catalyst includes a metal oxide. The metal oxide may include at least one metal selected from transition metal elements other than silver belonging to Groups 3 to 12 of the Periodic Table of Elements and metal elements belonging to Groups 13, 14 and 16 of the Periodic Table of Elements. That is, the second catalyst includes a metal oxide of a transition metal other than silver and a meta of Groups 13, 14 and 16. The metal oxide can provide active sites to activate a reducing agent used in a selective catalytic reduction (SCR) process. The activated reducing agent may be, for example, in the form of an enolic species or an acetate. The reducing agent activated by the metal oxide may react with the nitrogen oxide activated by the first catalyst to form an intermediate in the form of an isocyanate, and this intermediate may be converted into nitrogen by an additional reaction. The composition of the metal oxide may be determined, for example, by XPS, XRD, etc.

The second catalyst includes a metal oxide, and the metal oxide may provide an active site, for example a Bronsted acid site, that activates a reducing agent regardless of whether moisture is adsorbed. Therefore, the second catalyst can provide increased catalytic activity regardless of moisture content. In contrast, the first catalyst includes silver oxide, and the silver oxide may provide an active site, for example, a Bronsted acid site, that activates a reducing agent by adsorbing moisture onto the silver oxide. Therefore, the first catalyst can provide increased catalytic activity as moisture content increases, and can provide decreased catalytic activity as moisture content decreases.

The metal oxide may include Co, Rh, Ir, Cr, Mo, W, Se, Te, Po, Ti, V, Mn, Fe, Ni, Cu, Zn, Zr, or a combination thereof. Since the metal oxide includes such a metal, the catalyst composition can provide an improved nitrogen oxide conversion rate. The second catalyst may include, for example, Co_{c}O_{d} (1≤c≤5, 1≤d≤5), Rh_{c}O_{d} (1≤c≤5, 1≤d≤5), Ir_{c}O_{d} (1≤c≤5, 1≤d≤5), Cr_{c}O_{d} (1≤c≤5, 1≤d≤5), Mo_{c}O_{d} (1≤c≤5, 1≤d≤5), W_{c}O_{d} (1≤c≤5, 1≤d≤5), Se_{c}O_{d} (1≤c≤5, 1≤d≤5), Te_{c}O_{d} (1≤c≤5, 1≤d≤5), Po_{c}O_{d} (1≤c≤5, 1≤d≤5), Ti_{c}O_{d} (1≤c≤5, 1≤d≤5), V_{c}O_{d} (1≤c≤5, 1≤d≤5), Mn_{c}O_{d} (1≤c≤5, 1≤d≤5), Fe_{c}O_{d} (1≤c≤5, 1≤d≤5), Ni_{c}O_{d} (1≤c≤5, 1≤d≤5), Cu_{c}O_{d} (1≤c≤5,1≤d≤5), Zn_{c}O_{d} (1≤c≤5, 1≤d≤5), ZrcOd (1≤c≤5,1≤d≤5), or a combination thereof. The second catalyst may include, for example, CoO, CO₂O₃, CO₃O₄, CoO₂, CoO₃, RhO, Rh₂O₃, Rh₃O₄, RhO₂, Rh₂O₅, RhO₃, IrO, Ir₂O₃, Ir₃O₄, IrO₂, Ir₂O₅, IrO₃, CrO, Cr₂O₃, Cr₃O₄, CrO₂, Cr₂O₅, CrO₃, MoO, MO₂O₃, MO₃O₄, MoO₂, MO₂O₅, MOO₃, WO, W₂O₃, W₃O₄, WO₂, W₂O₅, WO₃, SeO, Se₂O₃, Se₃O₄, SeO₂, Se₂O₅, SeO₃, TeO, Te₂O₃, Te₃O₄, TeO₂, TezO₅, TeO₃, PoO, Po₂O₃, PO₃O₄, PoO₂, PO₂O₅, PoO₃, TiO, Ti₂O₃, Ti₃O₄, TiO₂, Ti₂O₅, TiO₃, VO, V₂O₃, V₃O₄, VO₂, V₂O₅, VO₃, MnO, Mn₂O₃, Mn₃O₄, MnO₂, Mn₂O₅, MnO₃, FeO, Fe₂O₃, Fe₃O₄, FeO₂, FezO₅, FeO₃, NiO, Ni₂O₃, Ni₃O₄, NiO₂, Ni₂O₅, NiO₃, CuO, Cu₂O₃, Cu₃O₄, CuO₂, Cu₂O₅, CuO₃, ZnO, Zn₂O₃, Zn₃O₄, ZnO₂, Zn₂O₅, ZnO₃, ZrO, Zr₂O₃, Zr₃O₄, ZrO₂, Zr₂O₅, ZrO₃, or a combination thereof.

The second catalyst includes, for example, a metal represented by M. The metal represented by M can activate nitrogen oxides (NOₓ). The metal represented by M can convert nitrogen oxides such as NO into activated nitrogen oxides such as NO₂ and NO₃. Activated nitrogen oxides may be converted to nitrogen by an additional reaction with an activated reducing agent.

The second catalyst includes, for example, a combination of a metal oxide and a metal. Since the second catalyst includes a combination of a metal oxide and a metal, nitrogen oxides (NOₓ) can be more effectively activated. The combination of a metal oxide and a metal may include, for example, a mixture thereof, a composite thereof, etc.

The second catalyst may include, for example, a mixture of a metal and a metal oxide, a composite of a metal and a metal oxide, or a combination thereof. The mixture of a metal and a metal oxide may include, for example, a mixture of M and MₐO_{b} (1≤a≤5, 1≤b≤5). The composite of a metal and a metal oxide may include, for example, a core-shell composite. The core of the core-shell composite may include M, and the shell of the core-shell composite may include MₐO_{b} (1≤a≤5, 1≤b≤5).

The second catalyst may include a crystalline metal oxide. Since the second catalyst includes a crystalline metal oxide, the catalytic activity of the catalyst composition can be further improved. The crystallinity of the second catalyst can be determined by XRD, TEM, or the like.

The catalyst composition may include, for example, a first catalyst and a second catalyst, wherein the first catalyst includes A_{g}Oₓ (0.5x<5), and the second catalyst includes Co_{c}O_{d} (1≤c≤5, 1≤d≤5), Co, a mixture of Co_{c}O_{d} (1≤c≤5, 1≤d≤5) and Co, a composite including a Co-containing core and a Co_{c}O_{d} (1≤c≤5, 1≤d≤5)-containing shell on the core, or a combination thereof. Since the catalyst composition has such a composition, the catalyst composition can provide an improved nitrogen oxide conversion rate.

The catalyst composition may include, for example, a first catalyst and a second catalyst, wherein the first catalyst includes A_{g}Oₓ (0.5≤x≤5), and the second catalyst includes Co_{c}O_{d} (1≤c≤5, 1≤d≤5). Since the catalyst composition has such a composition, the catalyst composition can provide an improved nitrogen oxide conversion rate.

The catalyst composition may include, for example, a first catalyst and a second catalyst, wherein the first catalyst includes Ag₂0, AgO, Ag₂O₃, A_{g}O_{y} (0.5<y<1), AgO_{y} (1<y<1.5), A_{g}O_{y} (1.5≤y≤5), or a combination thereof, and the second catalyst includes CoO, CO₂O₃, CO₃O₄, CoO₂, CoO₃, or a combination thereof. Since the catalyst composition has this composition, the catalyst composition can provide excellent catalytic activity even at low moisture content.

The catalyst composition may include, for example, a first catalyst and a second catalyst, wherein the first catalyst includes Ag₂O, and the second catalyst includes CO₃O₄. Since the catalyst composition has such a composition, the catalyst composition can provide high catalytic activity even at a relatively low temperature of 300° C. or lower.

The catalyst composition includes a support. The support may include a metal distinct from that in the first catalyst and the second catalyst.

The support supports the first catalyst and the second catalyst, prevents the aggregation of the first catalyst and the second catalyst, and provides an improved contact area. Since the first catalyst and the second catalyst are dispersed and supported on the support, more improved catalytic activity can be provided. The support is, for example, a porous support, and the porous support is, for example, a molecular sieve. Since the support has porosity, for example, since the support is a molecular sieve, the first catalyst and the second catalyst may be effectively supported on the support. For example, the first catalyst and the second catalyst may be impregnated into the support. The specific surface area of the support may be, for example, 10 square meters per gram (m^{2/}g) or more, 30 m^{2/}g or more, 50 m^{2/}g or more, or 100 m^{2/}g or more by a BET value.

The specific surface area of the support may be, for example, about 100 m^{2/}g to about 800m 2 /g, about 100 m^{2/}g to about 600 m^{2/}g, about 100 m^{2/}g to about 500 m^{2/}g, or about 100 m^{2/}g to about 400 m^{2/}g by a BET value. The specific surface area of the support may be measured, for example, by nitrogen adsorption. The support may have any pore volume and pore size. The pore volume and pore size of the support may be measured, for example, by nitrogen adsorption. The pore size of the support may be, for example, about 1 Å to about 1000 Å, about 1 Å to about 500 Å, about 1 Å to about 100 Å, about 1Å to about 50 Å, or about 1 Å to about 10 Å. The pore size may be, for example, a pore diameter. The support may include, for example, a mesoporous support. The mesoporous support may include pores having a size of, for example, about 2 nm to about 50 nm.

The support may be, for example, a molecular sieve. The molecular sieve may include, for example, a microporous molecular sieve having a maximum ring size of eight tetrahedral atoms, a mesoporous molecular sieve having a maximum ring size of ten tetrahedral atoms, a macroporous molecular sieve having a maximum ring size of twelve tetrahedral atoms, or a combination thereof. The specific surface area of the molecular sieve may be, for example, about 100 m²/g to about 800m² /g, about 100 m²/g to about 600 m²/g, about 100 m²/g to about 500 m²/g, or about 100 m²/g to about 400 m²/g by a BET value. The pore size of the molecular sieve may be, for example, about 1 Å to about 1000 Å, about 1 Å to about 500 Å, about 1 Å to about 100 Å, about 1 Å to about 50 Å, or about 1 Å to about 10 Å.

The support may include, for example, a carbon-containing support, a metal oxide-containing support, or a combination thereof. The carbon-containing support may include, for example, porous carbon. The carbon-containing support may include, for example, carbon black, active carbon, carbon nanotubes, or a combination thereof. The carbon-containing support may be doped with heterogeneous elements. The carbon-containing support may be doped with nitrogen (N), phosphorus (P), sulfur(S) atoms, etc. The metal oxide-containing support may include, for example, a refractory metal oxide. As used herein, the “refractory metal oxide” refers to a metal oxide having chemical and physical stability at high temperatures, such as temperatures associated with exhaust gases. The metal oxide-containing support may include, but is not limited to, alumina, titania, silica, zirconia, silica-alumina, aluminosilicate, alumina-zirconia, alumina-chromina, alumina-ceria, or a combination thereof. The metal oxide-containing support is, for example, alumina. The metal oxide-containing support may further include other materials known for such purposes. The metal oxide-containing support includes a combination of compounds doped with atoms, and includes a physical mixture or chemical combination thereof including high surface area or activated compounds, for example, activated alumina. The “high surface area” for refractory metal oxide supports refers to metal oxide support particles having large pores greater than 1 Å and a broad pore distribution. The refractory metal oxide support having a high surface area, for example, a support also referred to as “gamma alumina” or “activated alumina,” exhibit a BET surface area of, for example, 100 m²/g or more or 200 m²/g or more. Such activated alumina may be a mixture of gamma-phase alumina and delta-phase alumina, but may further include eta-phase alumina, kappa-phase alumina, and/or theta-phase alumina. The metal oxide-containing support may include activated alumina such as gamma-alumina having a high bulk density, macroporous gamma-alumina having a low or medium bulk density, and macroporous boehmite having a low bulk density. Combinations of the metal oxide-containing supports may include, but are not limited to, alumina-zirconia, lanthana-alumina, lanthana-zirconia-alumina, baria-alumina, baria-lantana-alumina, baria-lantana-neodymia-alumina, or combinations thereof. The metal oxide-containing support may include, but is not limited to, doped alumina, for example, Si-doped alumina, doped titania, for example, Si-doped titania, doped zirconia, for example, Si-doped zirconia, or a combination thereof.

The support may be, for example, a molecular sieve. The molecular sieve may include, for example, a carbon-containing molecular sieve, a metal oxide-containing molecular sieve, or a combination thereof. The carbon-containing molecular sieve may include, for example, porous carbon. The carbon-containing molecular sieve may include, for example, carbon black, active carbon, carbon nanotubes, or a combination thereof. The metal oxide-containing molecular sieve may include, but is not limited to, alumina, titania, silica, zirconia, silica-alumina, aluminosilicate, alumina-zirconia, alumina-chromina, alumina-ceria, or a combination thereof. Silica-alumina, aluminosilicate, alumina-zirconia, alumina-chromina, alumina-ceria, etc. may be classified as zeolites. The metal oxide-containing molecular sieve is, for example, alumina. For example, “gamma alumina”, also referred to as “active alumina,” has a BET surface area of 100 m²/g or more or 200 m²/g or more. The metal oxide-containing molecular sieve may include activated alumina such as gamma-alumina having a high bulk density, macroporous gamma-alumina having a low or medium bulk density, and macroporous boehmite having a low bulk density. Combinations of the metal oxide-containing molecular sieves may include, but are not limited to, alumina-zirconia, lanthana-alumina, lanthana-zirconia-alumina, baria-alumina, baria-lantana-alumina, baria-lantana-neodymia-alumina, or a combination thereof. The metal oxide-containing molecular sieve may include, but is not limited to, doped alumina, for example, Si-doped alumina, doped titania, for example, Si-doped titania, doped zirconia, for example, Si-doped zirconia, or a combination thereof.

The catalyst composition includes, for example, a support, and a first catalyst and a second catalyst supported on the support. Since the first catalyst and the second catalyst are supported on the support, catalytic activity can be further improved. The catalyst composition may include, for example, at least one of a first catalyst and a second catalyst supported on the support, and may include a second catalyst discontinuously applied on the surface of the first catalyst. The catalyst composition may include, for example, a first catalyst supported on the support, and a second catalyst discontinuously arranged on the first catalyst along the surface contour of the first catalyst. Since the catalyst composition has such an arrangement, the catalyst composition can provide an improved nitrogen oxide conversion rate. Alternatively, the catalyst composition may include, for example, at least one of a first catalyst and a second catalyst supported on the support, and may include a first catalyst discontinuously applied on the surface of the second catalyst. The catalyst composition may include, for example, a second catalyst supported on the support, and a first catalyst discontinuously arranged on the second catalyst along the surface contour of the second catalyst. Since the catalyst composition has such an arrangement, the catalyst composition can provide an improved nitrogen oxide conversion rate.

The content of the first catalyst may be, for example, about 0.05 wt % to about 30wt %, about 0.05 wt % to about 25 wt %, about 0.05 wt % to about 20 wt %, about 0.05 wt % to about 15 wt %, about 0.1 wt % to about 10 wt %, about 0.1 wt % to about 5 wt %, or about 0.1 wt % to about 1 wt % based on the total weight of the catalyst composition. Since the content of the first catalyst is within the above range, the catalyst composition can provide an improved nitrogen oxide conversion rate. The content of the second catalyst may be, for example, about 0.05 wt % to about 30 wt %, about 0.05 wt % to about 25 wt %, about 0.05 wt % to about 20 wt %, about 0.05 wt % to about 15 wt %, about 0.1 wt % to about 10wt %, about 0.1 wt % to about 5 wt %, or about 0.1 wt % to about 3 wt % based on the total weight of the catalyst composition. Since the content of the second catalyst is within the above range, the catalyst composition can provide an improved nitrogen oxide conversion rate.

In the catalyst composition, the weight ratio of the first catalyst and the second catalyst may be, for example, 1: about more than 0 to about 1:10, about 1:0.1 to about 1:8, about 1:0.2 to about 1:5, about 1:0.3 to about 1:5, about 1:0.3 to about 1:3, or about 1:0.3 to about 1:2.5. Since the weight ratio of the first catalyst and the second catalyst is within the above range, the catalyst composition can provide an improved nitrogen oxide conversion rate.

The particle diameter of the first catalyst in the catalyst composition may be, for example, 20 μm or less, 1 μm or less, 100 nm or less, 50 nm or less, 40 nm or less, or 30 nm or less. The particle diameter of the first catalyst in the catalyst composition may be about 0.1 nm to about 20 μm, about 0.1 nm to about 1 μm, about 1 nm to about 100 nm, about 1 nm to about 50 nm, about 3 nm to about 40 nm, or about 5 nm to about 30 nm. Since the particle diameter of the first catalyst is within the above range, the catalyst composition can provide an improved nitrogen oxide conversion rate. The particle diameter of the first catalyst may be measured by using a particle size analyzer (PSA) using laser diffraction. Alternatively, the particle diameter of the first catalyst may be measured by using a scanning electron microscope, a transmission electron microscope, or the like. The particle diameter of the first catalyst may be an arithmetic average of particle diameters of a plurality of particles, measured from a scanning electron microscope image. The particle diameter of the first catalyst may be measured automatically by software or manually. The particle diameter of the first catalyst may be an average particle diameter.

The particle diameter of the second catalyst in the catalyst composition may be 20 μm or less, 1 μm or less, 100 nm or less, 10 nm or less, 5 nm or less, or 1 nm or less. The particle diameter of the second catalyst in the catalyst composition may be about 0.1 nm to about 10 μm, about 0.1 nm to about 1 μm, about 1 nm to about 100 nm, about 1 nm to about 50 nm, about 3 nm to about 40 nm, or about 5 nm to about 30 nm. Since the particle diameter of the second catalyst is within the above range, the catalyst composition can provide an improved nitrogen oxide conversion rate. The particle diameter of the second catalyst may be measured by using a particle size analyzer (PSA) using laser diffraction. Alternatively, the particle diameter of the second catalyst may be measured by using a scanning electron microscope, a transmission electron microscope, or the like. The particle diameter of the second catalyst may be an arithmetic average of particle diameters of a plurality of particles, measured from a scanning electron microscope image. The particle diameter of the second catalyst may be measured automatically by software or manually. The particle diameter of the second catalyst may be an average particle diameter.

In the catalyst composition, the particle diameter of the first catalyst may be larger than the particle diameter of the second catalyst. Since the particle diameter of the first catalyst is larger than the particle diameter of the second catalyst, the second catalyst may be disposed on a surface of the first catalyst. The ratio of the particle diameter of the first catalyst and the particle diameter of the second catalyst may be about 1:0.01 to about 1:10, about 1:0.01 to about 1:5, about 1:0.01 to about 1:1, about 1:0.01 to about 1:0.5, or about 1:0.01 to about 1:0.1. Since the first catalyst and the second catalyst have a ratio of the particle diameter in this range, the catalyst composition can provide an improved nitrogen oxide conversion rate.

Exhaust gas containing nitrogen oxides (NOₓ) that come into contact with the catalyst composition may contain moisture. The content of moisture in the exhaust gas may be, for example, 50 vol. % or less, 30 vol. % or less, 10 vol. % or less, 5 vol. % or less, 3 vol. % or less, 2 vol. % or less, or 1 vol. % or less based on the total volume of the exhaust gas. The content of moisture in the exhaust gas may be, for example, about more than 0 vol. % to about 50 vol. %, about 0.01 vol. % to about 30 vol. %, about 0.1 vol. % to about 10 vol. %, about 0.1 vol. % to about 5 vol. %, about 0.1 vol. % to about 3 vol. %, about 0.1 vol. % to about 2 vol. %, or about 0.1 vol. % to about 1 vol. % based on the total volume of the exhaust gas. Since the content of moisture in the exhaust gas is within the above range, the catalyst composition can provide an improved nitrogen oxide conversion rate. The content of moisture in the exhaust gas may be measured by Fourier transform infrared spectroscopy (FT-IR).

Exhaust gas containing nitrogen oxides (NOₓ) that come into contact with the catalyst composition may further include a reducing agent. Since the exhaust gas includes a reducing agent, a catalytic reaction may be performed in a selective catalytic reduction (SCR) process. Removal of nitrogen oxides (NOₓ) can be performed more effectively. The exhaust gas may further include an alcoholic reducing agent. The alcoholic reducing agent can be activated by being adsorbed on the surface of at least one of the first catalyst and second catalyst of the catalyst composition. The catalyst composition may further include an alcohol, an alcohol derivative or a combination thereof adsorbed on at least one of the first catalyst and the second catalyst. An alcohol, an alcohol derivative, or a combination thereof adsorbed on at least one of the first catalyst and the second catalyst can more easily react with nitrogen oxides (NOₓ) adsorbed on at least one of the first catalyst and the second catalyst or disposed adjacent to at least one of the first catalyst and the second catalyst to convert nitrogen oxides (NOₓ) into nitrogen.

The alcoholic reducing agent is, for example, an alcohol. The alcohol may include a straight-chain or branched alcohol of 1 to 10 carbon atoms. The alcohol may include, for example, methanol, ethanol, propanol, isopropanol, butanol, pentanol, hexanol, heptanol, octanol, or a combination thereof. Since the alcoholic reducing agent includes such an alcohol, a selective catalytic reduction (SCR) process can be performed without a nitrogenous reducing agent such as ammonia.

The catalyst composition may be prepared by impregnating a first catalyst precursor and a second catalyst precursor into a support. The catalyst composition may be prepared by impregnating a support in the form of particulates with a solution including a first catalyst precursor and a second catalyst precursor, individually or as a mixture. As used herein, the “precursor” refers to a component, such as a metal, salt, ion, compound, etc., which can be decomposed or otherwise converted into a catalyst, that is, catalytically active species during sintering or use of the catalyst. The liquid medium used to impregnate the precursors into or deposit the precursors on the support does not react adversely with any component that may be present in the catalyst composition, and the liquid medium may be removed by dilution or decomposition upon heating and/or vacuum application. In the method of preparing a catalyst composition using such a liquid medium, a water-soluble compound, a water-soluble salt, a water-dispersible compound, a coordinate-complex of the first catalyst, a coordinate-complex of the second catalyst, or a combination thereof, which is used as a precursor. The first catalyst and the second catalyst may be described as being dispersed, impregnated, disposed, or contained in the support. The first catalyst and the second catalyst may be introduced into or onto the support by any suitable means, for example, impregnation, co-precipitation, or other known methods.

The catalyst composition may be prepared, for example, by a dry impregnation method, or alternatively, by a wet impregnation method. Dry impregnation methods or wet impregnation methods are commonly used in the synthesis of catalysts. In the dry impregnation method, for example, a first catalyst precursor, a second catalyst precursor, or a combination thereof is dissolved in an aqueous or organic solution and then a metal ion-containing solution is added to a support having a pore volume equal to or greater than the volume of the added solution. The solution is absorbed into the pores of the support by capillary action. The solution added in excess of the support pore volume changes solution transport from a capillary process to a much slower diffusion process. Subsequently, the impregnated support may be dried and calcined to remove volatile components in the solution, thereby allowing the first catalyst and the second catalyst to be supported on the surface of the support. The loading amount of the catalyst supported on the support depends on the solubility of the precursors. Alternatively, the catalyst composition may be prepared by a wet impregnation method. In the wet impregnation method, an excess of a precursor-containing solution may be used relative to the saturation volume of the support. A support is added to an excess of a precursor solution containing a first catalyst precursor and a second catalyst precursor to prepare a catalyst slurry. The catalyst slurry may be heated at an elevated temperature until it is dry to remove volatile components, thereby supporting a first catalyst and a second catalyst on the surface of a support. The loading amount of the catalysts supported on the support may depend on the solubility of the precursors and the volume of the precursor-containing solution.

The catalyst composition may be prepared by the following method.

First, a first catalyst precursor and a second catalyst precursor may be simultaneously or sequentially impregnated into or onto a support to prepare a support impregnated with the first catalyst precursor and the second catalyst precursor.

The support impregnated with the first catalyst precursor and the second catalyst precursor may be prepared by putting the first catalyst precursor, the second catalyst precursor, and the support into a solvent, mixing them, and then removing the solvent. The solvent may be distilled water, an organic solvent, or a combination thereof. Silver ions of the first catalyst precursor and metal ions of the second catalyst precursor may be impregnated into the inside of the pores of the support and onto the surface of the pores of the support, which is a porous material. The first catalyst precursor may be, but is not limited to, silver nitride, silver hydroxide, silver sulfide, silver sulfate or silver chloride. The first catalyst precursor may be, for example, Ag(NO)3. The second catalyst precursor may be, but is not limited to, a metal chloride, a metal nitride, a metal hydroxide, a metal sulfide or a metal sulfate, including a metal of Groups 3 to 14 and 16 of the Periodic Table of Elements other than silver. The second catalyst precursor may include, for example, cobalt (Co) chloride, cobalt (Co) nitride, cobalt (Co) hydroxide, cobalt (Co) sulfide, rhodium (Rh) chloride, rhodium (Rh) nitride, rhodium (Rh) hydroxide, rhodium (Rh) sulfide, chromium (Cr) chloride, chromium (Cr) nitride, chromium (Cr) hydroxide, chromium (Cr) sulfide, molybdenum (Mo) chloride, molybdenum (Mo) nitride, molybdenum (Mo) hydroxide, molybdenum (Mo) sulfide, tungsten (W) chloride, tungsten (W) nitride, tungsten (W) hydroxide, tungsten (W) sulfide, selenium (Se) chloride, selenium (Se) nitride, selenium (Se) hydroxide, Selenium (Se) sulfide, tellurium (Te) chloride, tellurium (Te) nitride, tellurium (Te) hydroxide, tellurium (Te) sulfide, titanium (Ti) chloride, titanium (Ti) nitride, titanium (Ti) hydroxide, titanium (Ti) sulfide, vanadium (V) chloride, vanadium (V) nitride, vanadium (V) hydroxide, vanadium (V) sulfide, manganese (Mn) chloride, manganese (Mn) nitride, manganese (Mn) hydroxide, manganese (Mn) sulfide, iron (Fe) chloride, iron (Fe) nitride, iron (Fe) hydroxide, iron (Fe) sulfide, nickel (Ni) chloride, nickel (Ni) nitride, nickel (Ni) hydroxide, nickel (Ni) sulfide, copper (Cu) chloride, copper (Cu) nitride, copper (Cu) hydroxide, copper (Cu) sulfate, zinc (Zn) chloride, zinc (Zn) nitroxide, zinc (Zn) hydroxide, zinc (Zn) sulfate, zirconium (Zr) chloride, zirconium (Zr) nitroxide, zirconium (Zr) hydroxide, zirconium (Zr) sulfate, or a combination thereof. The second catalyst precursor may include, for example, Co(NO₃)₂·6H₂O.

Next, the support impregnated with the first catalyst precursor and the second catalyst precursor may be sintered to prepare a catalyst composition in which the first catalyst and the second catalyst are supported on the support.

Sintering temperature may be, for example, about 300° C. to about 800° C., about 300° C. to about 750° C., about 350° C. to about 750° C., about 350° C. to about 700° C., about 400 ° C. to about 700° C., about 400° C. to about 650° C., about 400° C. to about 600° C., about 450° C. to about 600° C., or about 450° C. to about 550° C. The sintering time may be about 10 minutes to about 48 hours, about 20 minutes to about 36 hours, about 30 minutes to about 24 hours, about 1 hour to 12 hours, or about 3 hours to 8 hours. Sintering atmosphere may be, for example, an air atmosphere. By sintering, silver ions of the first catalyst precursor supported on the support may be oxidized into silver oxide to form the first catalyst, and metal ions of the second catalyst precursor may be oxidized into metal oxide to form the second catalyst. Impregnation and sintering may be repeated sequentially one or more times depending on the required conditions. The content of the first catalyst may be about 0.1 parts by weight to about 30 parts by weight, about 0.1 parts by weight to about 20 parts by weight, about 0.1 parts by weight to about 15 parts by weight, about 0.1 parts by weight to about 10 parts by weight, about 0.1 parts by weight to about 5 parts by weight, or about 0.1 parts by weight to about 1 part by weight, based on 100 parts by weight of the support. The content of the second catalyst may be about 0.1 parts by weight to about 30 parts by weight, about 0.1 parts by weight to about 20parts by weight, about 0.1 parts by weight to about 15 parts by weight, about 0.1 parts by weight to about 10 parts by weight, about 0.1 parts by weight to about 5 parts by weight, or about 0.1 parts by weight to about 3 parts by weight, based on 100 parts by weight of the support.

Next, a process of aging the catalyst composition prepared by sintering may be further included. Aging may be performed under various conditions. The aging process may be omitted. As used herein, the “aging” refers to including various conditions, such as temperature, time, and atmosphere. Aging may be performed under various conditions depending on the required conditions. The aging process may be performed under a steam of about 0% to 20%. The aging process may be performed for about 5 hours to about 50 hours. The aging process may be performed at about 500° C. to about 800° C. The aging process may be performed at 600° C. for 40 hours under a steam of 0%, 700° C. for 20 hours under a steam of 0%, or 800° C. for 15 hours under a steam of 0%. Alternatively, the aging process may be performed at 600° C. for 40 hours under a steam of 5%, 700 ° C. for 20 hours under a steam of 5%, or 800° C. for 15 hours under a steam of 5%. The above-described catalyst composition may decompose and remove at least a portion of nitrogen oxides (NOₓ) contained in exhaust gas.

The catalyst composition may decompose and/or reduce 40% or more, 45% or more, 50% or more, 55% or more, 60% or more, 65% or more, 70% or more, 75% or more, 80% or more, 85% or more, 90% or more, or 95% or more of the total nitrogen oxides contained in the exhaust gas or exhaust gas stream, by weight, volume, or mole. That is, the catalyst composition may provide a conversion rate, i.e., a catalytic activity, of 40% or more, 45% or more, 50% or more, 55% or more, 60% or more, 65% or more, 70% or more, 75% or more, 80% or more, 85% or more, 90% or more, or 95% or more of the total nitrogen oxides contained in the exhaust gas or exhaust gas stream, by weight, volume, or mole. The exhaust gas from which the activity of the catalyst composition is measured may have a composition including 100 parts per million (ppm) NO, 133 ppm isopropanol (IPA), 20% oxygen, 9% carbon dioxide, 1.6% to 15% moisture (H₂O), and a balance of nitrogen by volume. The velocity of the exhaust gas at which the activity of the catalyst composition is measured may be a space velocity of 100,000 per hour (h⁻¹) and a linear velocity of 0.7 meters per second (m/s).

### Catalyst Article

A catalyst article according to another embodiment includes a substrate, and a coating film disposed on the substrate. The coating film includes the above-described catalyst composition.

Since the catalyst article includes the above-described catalyst composition, the conversion rate of nitrogen oxides in the exhaust gas passing through the catalyst article can be improved.

The substrate is three-dimensional, and may have various cross-sectional shapes such as circle, square, and rectangle. The substrate may have a length, diameter, and volume similar to those of a square pipe. The substrate may have a length, diameter, and volume similar to those of a cylinder. The length of the substrate is an axial length defined by an inlet end to an outlet end. The substrate may be a honeycomb substrate. The honeycomb substrate may be made of metal or ceramic. A catalyst composition may be applied onto a substrate to attach a coating film, thereby providing a plurality of wall surfaces that act as a substrate for a catalyst. The ceramic substrate may include a refractory material such as cordierite, cordierite-a-alumina, aluminum titanate, silicon titanate, silicon carbide, silicon nitride, zircon mullite, spodumene, alumina-silica-magnesia, zircon silicate, sillimanite, magnesium silicate, zircon, petalite, a-alumina, or aluminosilicate. The metallic substrate may include at least one metal or metal alloy. The metallic substrate may include any metallic substrate having an opening or “punch-out” in the channel wall thereof. The metallic substrate may have various forms, such as pellets, compressed metal fibers, corrugated cardboard, monolithic foam, etc. The metallic substrate may include a refractory metallic alloy including essentially iron or including iron as a major component. The refractory metallic alloy may include one or more of nickel, chromium, and aluminum, and the total amount of these metals may comprise 15 wt. % or more of an alloy. The refractory metallic alloy may include about 10 wt % to about 25 wt % of chromium, about 1 wt % to about 8 wt % of aluminum, and about 0 wt % to about 20 wt % of nickel, based on the total weight of the substrate. Examples of the metallic substrate includes a substrate having straight channels; a substrate having blades protruding along axial channels to hinder gas flow and open the communication of gas flow between the channels; and a substrate having blades and also holes that enhance gas transport between the channels, thereby enabling radial gas transport throughout a monolith.

The honeycomb substrate may be a flow-through substrate or a wall-flow substrate.

The honeycomb substrate is, for example, a flow-through substrate.

The flow-through substrate has fine and parallel gas flow passages extending from the inlet end of the substrate to the outlet end thereof such that passages are open to fluid flow. A passage, which is essentially a straight path from the fluid inlet to the fluid outlet, is defined by a wall arranged so that exhaust gas flowing through the passage contacts a catalyst, and a coating film containing the catalyst composition is disposed on or within the wall. The flow passage of the flow-through substrate is a thin-walled channel. The flow passage of the flow-through substate may have any suitable cross-sectional shape and size, such as a trapezoid, rectangle, square, sine wave, hexagon, ellipse, circle, etc. The flow-through substate may be made of ceramic or a metal, as described above. The flow-through substate may have a volume of about 50 cubic inch (in³) to about 1200 in³, a cell density (inlet opening) of about 60 cells per square inch (cpsi) to about 900 cpsi or less or about 500 cpsi or less, for example, about 100 cpsi to about 400 cpsi, and a wall thickness of about 50 μm to about 400 micrometers (μm) or about 50 μm to about 100 μm.

The honeycomb substrate is, for example, a wall-flow substrate. The wall-flow substrate has a plurality of fine and substantially parallel gas flow passages extending along the longitudinal axis of the substrate. The wall-flow substrate is, for example, a wall-flow filter. In the wall-flow substrate, each of the flow passages may be blocked at one end of the substrate body, and the alternating passage may be blocked at the opposite end thereof. The wall-flow substrate may include about 900 or more flow passages (or “cells”) per square inch of cross-section, but far fewer flow passages may be used. The wall-flow substrate may have a cell density of about 7 cpsi to about 600 cpsi or about 100 cpsi to about 400 cpsi. The cell of the wall-flow substrate may have a cross-section that is rectangular, square, circular, oval, triangular, hexagonal, or other polygonal in shape. The wall-flow substrate may be made of ceramic or a metal, as described above, The wall-flow substrate may have a volume of about 50 in³ to about 5000 in³, about 100 in³ to about 4500 in³, about 200 in³ to about 4000 in³, about 300 in³ to about 3500 in³, about 400 in³ to about 3000 in 3, about 500 in³ to about 2500 in³, about 600 in 3to about 2000 in³, about 700 in³ to about 1500 in³, about 800 in³ to about 1500 in³, or about 900 in³ to about 1500 in³ . The wall-flow substrate may have a wall thickness of about 50 μm to about 2000 μm, about 50 μm to about 450 μm, or about 150 μm to about 400 μm. The wall of a wall-flow substrate is, for example, porous. The wall-flow substrate may have a wall porosity of 40 % or more, 50 % or more, 55 % or more, 60 % or more, 65 % or more, or 70% or more. The average pore diameter before placement of the coating film including the catalyst composition may be 5 μm or more, 10 μm or more, 20 μm or more, 30 μm or more, or 40 μm or more.

The coating film may be prepared by contacting a coating slurry with the above-described substrate to provide coating. The coating slurry may further include a binder in addition to the catalyst composition.

Examples of the binder may include alumina, silica, zirconium acetate, colloidal zirconia, zirconium hydroxide, boehmite, gamma-alumina, delta/theta alumina, silica sol, thickeners, anionic surfactants, cationic surfactants, nonionic surfactants, and amphoteric surfactants. The content of the binder may be about 1 wt % to about 10 wt % or about 1 wt % to about 5 wt % of the total weight of the coating slurry. The pH of the coating slurry may be about 3 to about 6. The coating slurry may include a liquid medium. The liquid medium may be an aqueous solution or an organic solution. The coating slurry may be subjected to milling to decrease a particle size and increase particle mixing. The milling may be accomplished by a ball mill, a continuous mill, etc. The content of solids in the coating slurry may be about 10 wt % to about 60 wt %, about 10 wt % to about 50 wt %, or about 20 wt % to about 40 wt %.

The coating film may be introduced onto the substrate or into the substrate by applying the coating slurry containing the liquid medium onto the substrate, drying and sintering the applied coating slurry. The drying may be performed at about 100° C. to about 150° C. for about 10 hours to about 4 hours. The gas atmosphere during the drying may be an oxygen or air atmosphere. The sintering may be performed at about 300° C. to about 900° C. for about 10 hours to about 8 hours. The gas atmosphere during the sintering may be an oxygen or air atmosphere.

The coating film may have a single-layer structure or a multi-layer structure. The coating film may extend from the inlet end and/or outlet end of the substrate. An undercoat may additionally be placed between the coating film and the substrate. By the undercoat, at least a portion of the coating film may be in contact with the undercoat without contacting the substrate. An overcoat may additionally be placed on the coating film. By the overcoat, at least a portion of the coating film may not be directly exposed to exhaust gas.

The catalyst article may be a catalyst filter. The catalyst filter may include a honeycomb substrate, and the catalyst filter may include a flow-through substrate or a wall-flow substrate.

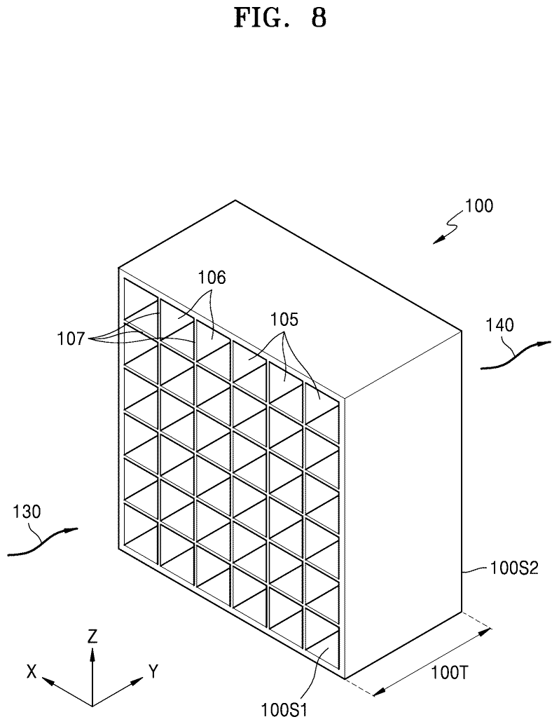

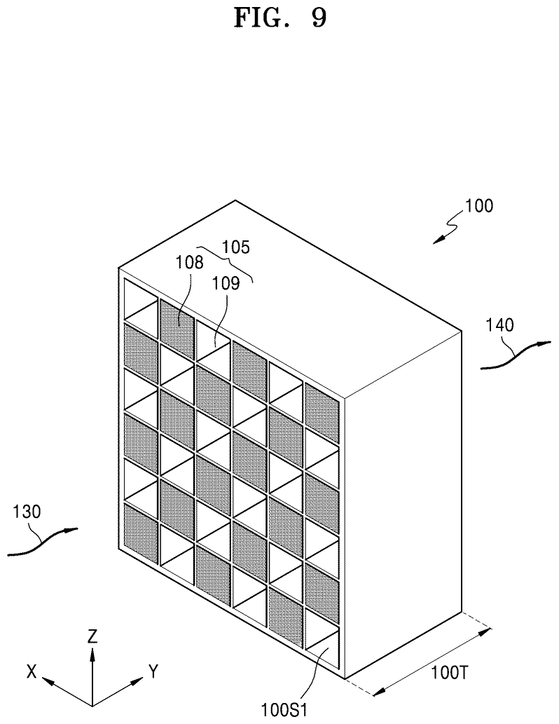

FIG. 8 is a schematic view of a catalyst filter including a flow-through substrate according to an embodiment. FIG. 9 is a schematic view of a catalyst filter including a wall-flow substrate according to another embodiment.

Referring to FIGS. 8 and 9, a catalyst filter (100) includes a plurality of cells 105 arranged parallel to each other and adjacent to each other and forming exhaust gas flow passages on an inlet cross-section 100S1 along a thickness direction 100T of the catalyst filter. The plurality of cells 105 arranged in parallel are arranged, for example, regularly or irregularly. Since the catalyst filter 100 includes the plurality of cells 105 arranged with such a pattern, nitrogen oxides (NOₓ) can be effectively removed from untreated exhaust gas 130.

Referring to FIG. 8, the catalyst filter 100 includes a flow-through substrate. The catalyst filter 100 includes a plurality of cells 105 arranged adjacent to each other and in parallel to each other, and the plurality of cells 105 include through-holes 106 and walls 107 defining the shape of the through-holes 106. The through-holes 106 form exhaust gas flow passages that penetrates an inlet cross-section 100S1 and an outlet cross-section 100S2. Each of the wall 107 is placed between the adjacent through-holes 106. The area occupied by the through-holes 106 in the inlet cross-section 100S1 is, for example, about 50% to about 99%, about 60% to about 99%, about 70% to about 99%, about 80% to about 99%, or about 90% to about 99% of the total area of the inlet cross-section 100S1.

Referring to FIG. 9, the catalyst filter 100 includes a wall-flow substrate. The catalyst filter 100 includes a plurality of cells 105 arranged adjacent to each other and parallel to each other. The plurality of cells 105 include outlet channels 108 and/or inlet channels 109. Each of the outlet channels 108 is blocked at an inlet end, and each of the inlet channels 109 is blocked at an outlet end. Since the plurality of cells 105 alternately include the outlet channels 108 and/or the inlet channels 109, the contact area between the exhaust gas 130 and the catalyst filter 100 is maximized. The outlet channel 108 and/or the inlet channel 109 are, for example, porous. Since the outlet channel 108 and/or the inlet channel 109 are porous, the untreated exhaust gas 130 is treated as it passes through the outlet channel 108 and/or the inlet channel 109.

Referring to FIG. 8, the inlet of the through-hole 106 may be circular, oval, triangular, square, pentagonal, hexagonal, octagonal, or a combination thereof, but is not limited thereto, and any shape suitable for treating the untreated exhaust gas 130 is possible. Referring to FIG. 9, the inlet end of the outlet channel 108 may be circular, oval, triangular, square, pentagonal, hexagonal, octagonal, or a combination thereof, but is not limited thereto, and any shape suitable for treating the untreated exhaust gas 130 is possible. The outlet end of the inlet channel 109 may be circular, oval, triangular, square, pentagonal, hexagonal, octagonal, or a combination thereof, but is not limited thereto, and any shape suitable for treating the untreated exhaust gas 130 is possible Referring to FIG. 8, the diameter of the through-hole 106 may increase, decrease, or maintain constant along the thickness direction 100T of the catalyst filter, but is not limited thereto, and any pattern suitable for treating the untreated exhaust gas 130 is possible. Referring to FIG. 9, the diameter of the outlet channel 108 may increase, decrease, or maintain constant along the thickness direction 100T of the catalyst filter, but is not limited thereto, and any pattern suitable for treating the untreated exhaust gas 130 is possible. The diameter of the inlet channel 109 may increase, decrease, or maintain constant along the thickness direction 100T of the catalyst filter, but is not limited thereto, and any pattern suitable for treating the untreated exhaust gas 130 is possible.

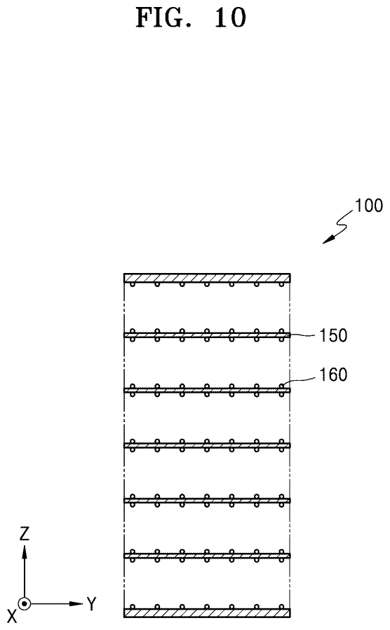

FIG. 10 is a cross-sectional view of the catalyst filter 100 taken along the vertical (Z axis) line in FIG. 8.

The catalyst filter 100 includes a flow-through substrate 150 and a coating film 160 disposed on the flow-through substrate 150, and the coating film 160 includes a catalyst composition. The catalyst composition includes a first catalyst, a second catalyst, and a support. When exhaust gas passes through the catalyst filter 100 together with a reducing agent such as isopropanol, it comes into contact with the coating film 160 and reacts with the catalyst composition of the coating film 160, thereby allowing nitrogen oxides (NOₓ) in the exhaust gas to be treated. For specific details on the first catalyst, second catalyst and support, refer to the above-described catalyst composition. The flow-through substrate 150 may include ceramic, carbon, polymer, metal, nonwoven fabric, woven fabric, or a combination thereof.

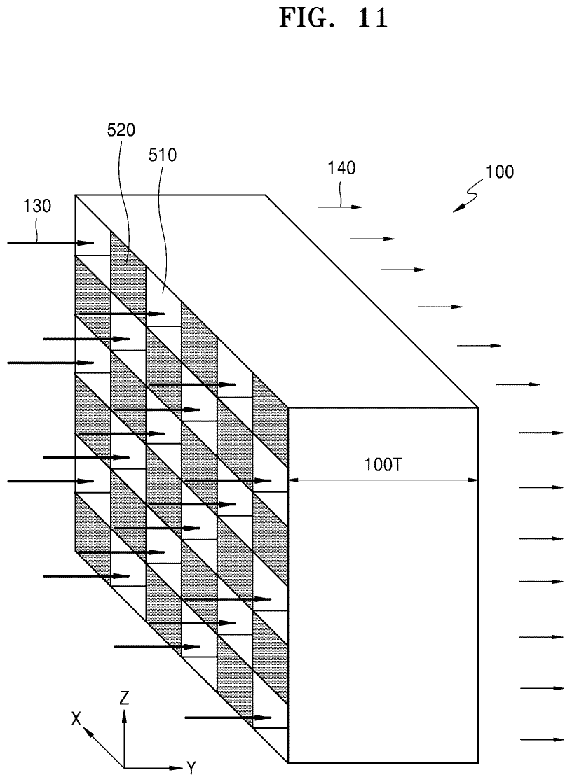

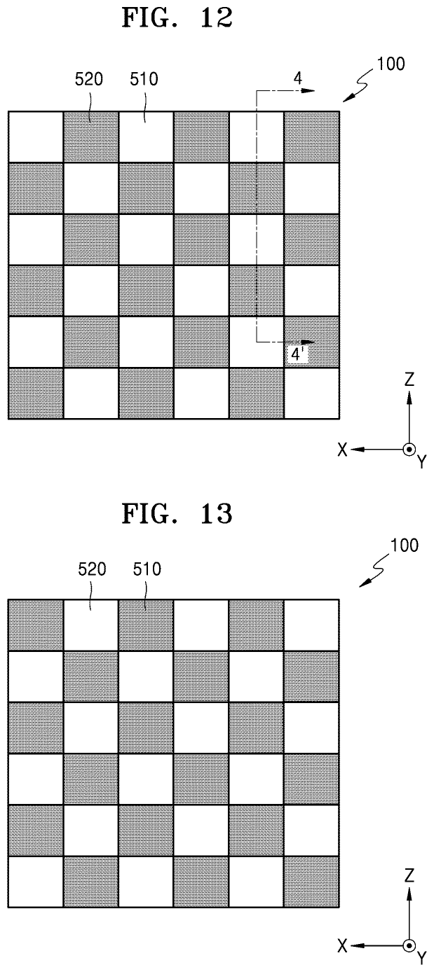

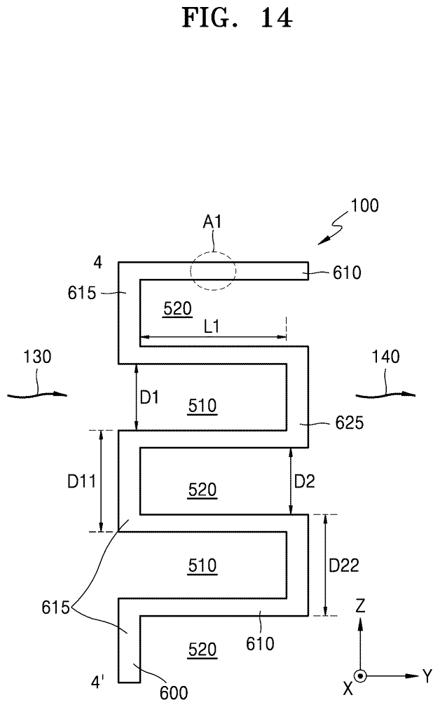

FIG. 11 is a schematic perspective view of a catalyst filter according to another embodiment. FIG. 12 is a front view of an inlet surface of untreated exhaust gas 130 of the catalyst filter 100 of FIG. 11. FIG. 13 is a front view of an outlet surface of treated exhaust gas 140 of the catalyst filter 100 of FIG. 11 FIG. 14 is a cross-sectional view of the catalyst filter 100 taken along the line 4-4′ in FIG. 12.

Referring to FIGS. 11 and 12, a catalyst filter 100 includes an inflow surface through which untreated exhaust gas 130 is introduced and an outflow surface through which treated exhaust gas 140 is discharged. The untreated exhaust gas 130 includes nitrogen oxides (NOₓ) that are decomposed by the catalyst composition. The untreated exhaust gas 130 may include a particulate compound and a gaseous compound. The catalyst filter 100 has a thickness 100T defined in the direction extending from the inflow surface toward the outflow surface (Y-axis direction). The catalytic filter 100 includes a plurality of inlet channels 510 each having an open inlet end at an inflow surface through which untreated exhaust gas 130 is introduced and a closed outlet end at an outflow surface through which treated exhaust gas 140 is discharged. The catalytic filter 100 includes a plurality of outlet channels 520 each having a closed inlet end at an inflow surface through which untreated exhaust gas 130 is introduced and an open outlet end at an outflow surface through which treated exhaust gas 140 is discharged. The plurality of outlet channels 520 may be arranged regularly and/or periodically. The plurality of outlet channels 520 may be arranged parallel to each other. The plurality of outlet channels 520 are arranged between the plurality of inlet channels 510, respectively. The treated exhaust gas 140 is discharged from the catalyst filter 100 through the plurality of outlet channels 520. The outlet channels 520 are arranged to be spaced apart from each other between the inlet channels 510 arranged spaced apart from each other along the inflow surface in one direction, for example, along the X-axis direction and/or the Z-axis direction. The inlet channels 510 and the outlet channels 520 are arranged alternately along the outflow surface in one direction, for example, along the X-axis direction and/or the Z-axis direction. One inlet channel 510 is surrounded by four outlet channels 520, and one outlet channel 520 is surrounded by four inlet channels 510.

Referring to FIGS. 11 and 12, the inflow surface of the catalyst filter 100 includes inlet channels 510 having a plurality of open inlet ends and outlet channel 520 having a plurality of closed inlet ends.

Referring to FIGS. 11 and 13, the outflow surface of the catalyst filter 100 includes outlet channels 520 having a plurality of closed outlet ends and inlet channel 510 having a plurality of open outlet ends.

FIG. 14 is a cross-sectional view of the catalyst filter 100 taken along the line 4-4′ in FIG. 12.

The substrate of the catalyst filter 100 may be a single body or a monolithic structure, or may be a single body or a monolithic frame. The substrate of the catalyst filter 100 may have a frame formed entirely of the same material, for example, a ceramic material, a polymer material, a metal material, etc. Alternatively, the substrate of the catalyst filter 100 may be a multi-layer structure or a multi-layer frame. The catalyst filter 100 may have a multi-layer structure including a wall-flow substrate and a coating film containing a catalyst composition and disposed on the wall-flow substrate.

Referring to FIG. 14, the catalyst filter 100 is a structure having a frame in which a plurality of inlet channels 510 and a plurality of outlet channels 520 are alternately arranged in the Z-axis direction or the X-axis direction. The catalyst filter 100 includes a plurality of walls 610 and a plurality of closed inlet ends 615 and a plurality of closed outlet ends 625. The plurality of walls 610 are arranged to be spaced apart from each other along the Z-axis direction. The Z-axis direction corresponds to a vertical direction. The plurality of walls 610 are arranged parallel to each other along the Y-axis direction. The lengths of the plurality of walls 610 are equal to or different from each other. The plurality of wall 610 is arranged between the plurality of closed inlet ends 615 and the plurality of closed outlet ends 625. The plurality of walls 610 are physically connected to each other through the plurality of closed inlet ends 615 and the plurality of closed outlet ends 625. The plurality of closed inlet ends 615 and the plurality of closed outlet ends 625 are arranged parallel to each other, and are arranged to be spaced apart from each other. The plurality of closed inlet ends 615 and the plurality of closed outlet ends 625 are arranged to be spaced apart from each other along the Z-axis direction. The Z-axis direction corresponds to a vertical direction. The plurality of closed inlet ends 615 and the plurality of closed outlet ends 625 are arranged parallel to each other along the Y-axis direction. The lengths of the plurality of closed inlet ends 615 are equal to or different from each other, and the lengths of the plurality of closed outlet ends 625 are equal to or different from each other. The plurality of closed inlet ends 615 and the plurality of closed outlet ends 625 are arranged between the plurality of walls 610. The plurality of closed inlet ends 615 and the plurality of closed outlet ends 625 are physically connected to each other through the plurality of walls 610. The plurality of closed inlet ends 615 and the plurality of closed outlet ends 625 are arranged to be spaced apart from each other along the Y-axis direction. The plurality of closed inlet ends 615 and the plurality of closed outlet ends 625 are arranged to be spaced apart from each other along the Z-axis direction. The plurality of closed inlet ends 615 are arranged on the inflow surface through which the untreated exhaust gas 130 is supplied. The plurality of closed outlet ends 625 are arranged on the outflow surface through which the treated exhaust gas 140 is discharged.

The wall 610 is placed between the closed inlet end 510 and the closed outlet end 520 to form a boundary between the inlet channel 510 and the outlet channel 520. The wall 610 corresponds to the side wall of the inlet channel 510 and the side wall of the outlet channel 520. The thicknesses of the plurality of walls 610 are equal to or different from each other. The thickness of the wall 610 is equal to or different from the thickness of the closed inlet end 615 and the thickness of the closed outlet end 625. The walls 610 defining the inlet channel 510 are arranged to be spaced apart by a first interval D1 in the Z-axis direction. The walls 610 defining the outlet channel 520 are arranged to be spaced apart by a second interval D2 in the Z-axis direction. The first interval D1 and the second interval D2 are equal to or different from each other. The diameters and/or areas of the inlet channel 510 and the outlet channel 520 are equal to or different from each other. The Y-axis lengths L1 of the plurality of walls 610 are equal to or different from each other. The depth of the inlet channel 510 and the depth of the outlet channel 520 are defined by the Y-axis length L1 of the wall 610. The depth of the inlet channel 510 and the depth of the outlet channel 520 are equal to or different from each other. The plurality of closed inlet ends 615 form the inlet of the outlet channel 520. The plurality of closed outlet ends 625 form the outlet of the inlet channel 510. The air permeability of the outlet of the inlet channel 510 and the air permeability of the inlet of the outlet channel 520 are the same as or different from each other. The diameter D11 of the closed inlet end 615 and the diameter D22 of the closed outlet end 625 are equal to or different from each other. The Y-axis thicknesses of the closed inlet end 615 and the Y-axis thicknesses of the closed outlet end 625 are equal to or different from each other.

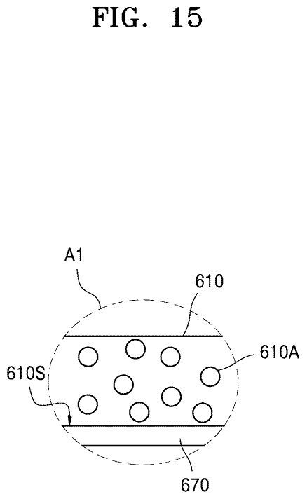

FIG. 15 is an enlarged view of the first portion A1 of the wall 610 of FIG. 14.

Referring to FIG. 15, the wall 610 is a porous wall 610 including pores 610A. The closed inlet end 615 and the closed outlet end 625 may or may not include pores. The wall 610, the closed inlet end 615, and the closed outlet end 625 may include pores. The pore density of the closed inlet end 615 and the pore density of the closed outlet end 625 may be higher than, lower than, or equal to the pore density of the wall 610. The closed inlet end 615 may include pores, and the closed outlet end 625 may not include pores. Alternatively, the closed inlet end 615 may not include pores, and the closed outlet end 625 may include pores. The closed inlet end 615 and the closed outlet end 625 may include pores, and the pore density of the closed outlet end 625 may be higher than, lower than, or equal to the pore density of the closed inlet end 615. A coating film 670 including the above-described catalyst composition is placed on one side 610S of the wall 610. The coating film 670 includes a catalyst composition, and the catalyst composition includes a first catalyst, a second catalyst, and a support. The coating film 670 may be placed on the wall 610, the closed inlet end 615, and the closed outlet end 615.

The untreated exhaust gas 130 introduced into the inlet channel 510 may be forced to pass through the wall 610 before being discharged from the outlet channel 520. As the untreated exhaust gas 130 introduced into the inlet channel 510 passes through the wall 160, it comes into contact with a coating film (not shown) containing a catalyst composition disposed on the wall 160, thereby removing at least a portion of nitrogen oxides (NOₓ) and thus obtaining treated exhaust gas 140. The treated exhaust gas 140 is discharged through the outlet channel 520.

Exhaust gas treatment method An exhaust gas treatment method according to an embodiment, which is a method of treating exhaust gas containing nitrogen oxide (NOₓ), includes a process of contacting exhaust gas with an alcoholic reducing agent in the presence of the above-described catalyst composition.

Nitrogen oxides (NOₓ) in the exhaust gas can be removed with high efficiency by contacting the exhaust gas with an alcoholic reducing agent in the presence of the catalyst composition. The catalyst composition includes a first catalyst, a second catalyst and a support. For more specific details on the catalyst composition, refer to the above-described catalyst composition.

The alcoholic reducing agent includes, for example, alcohols. The alcohols include, for example, alcohols of 1 to 10 carbon atoms. The alcohols include, for example, methanol, ethanol, n-propanol, isopropanol, butanol, pentanol, hexanol, heptanol, octanol, or a combination thereof. The catalytic reaction of a selective catalytic reduction (SCR) process can be performed by contacting the exhaust gas with the alcoholic reducing agent.

In the process of contacting the exhaust gas with the alcoholic reducing agent, the mixing ratio of the nitrogen oxides and the alcoholic reducing agent may be about 1:1 to about 1:10, about 1:1 to about 1:5, about 1:1 to about 1:3, or about 1:1 to about 1:2 in volume ratio (e.g., molar ratio). An improved nitrogen oxide conversion rate can be provided by mixing the nitrogen oxides and the alcoholic reducing agent in this volume ratio (e.g., molar ratio).

The exhaust gas may further include moisture. The content of moisture in the exhaust gas may be 50 volume percent (vol. %) or less, 40 vol. % or less, 30 vol. % or less, 20 vol. % or less, 10 vol. % or less, 5 vol. % or less, 3 vol. % or less, or 2 vol. % or less based on the total volume of the exhaust gas. A high nitrogen oxide conversion rates of 50% or more, 60% or more, or 70% or more can be provided with respect to the exhaust gas having a low moisture content.

The contacting of the exhaust gas with the alcoholic reducing agent may be performed at about 150° C. to about 400° C., about 200° C. to about 400° C., about 200° C. to about 350° C., about 200° C. to about 300° C., or about 250 to about 300° C. Even when the contacting of the exhaust gas with the alcoholic reducing agent is performed at relatively low temperatures, high nitrogen oxide conversion rates can be provided.

### Exhaust Gas Treatment System

An exhaust gas treatment system according to an embodiment, which is a system for treating exhaust gas containing nitrogen oxides (NOₓ), includes the above-described catalyst article located downstream from an emission source emitting the nitrogen oxides in fluid communication with the emission source.

Since the exhaust gas treatment system includes the above-described catalyst article, nitrogen oxides contained in the exhaust gas can be removed with high efficiency.

The exhaust gas treatment system may further include an alcohol injector located upstream of the catalyst article and arranged in fluid communication with the catalyst article. The alcohol injector can improve the removal efficiency of nitrogen oxides by supplying alcohol, which is an alcoholic reducing agent required for the selective catalytic reduction (SCR) process, to the exhaust gas. For example, methanol, ethanol, normal propanol, isopropanol, butanol, pentanol, hexanol, heptanol, octanol or a combination thereof can be supplied to the upstream of the catalyst article in the exhaust gas treatment system through the alcohol injector. Alcohol may be supplied in the form of a gas, a liquid, or a combination thereof.

The exhaust gas treatment system may further include a catalyzed soot filter (CSF) located upstream or downstream of the catalyst article and arranged in fluid communication with the catalyst article. Since the exhaust gas treatment system further includes the catalyzed soot filter (CSF), particulate matter contained in the exhaust gas can be more efficiently removed.

The exhaust gas treatment system may further include a diesel oxidation catalyst (DOC) located upstream or downstream of the catalyst article and arranged in fluid communication with the catalyst article. Since the exhaust gas treatment system further includes the diesel oxidation catalyst (DOC), hydrocarbon, carbon monoxide, and the like contained in the exhaust gas can be more efficiently removed.

Examples of the emission source of the exhaust gas include, but are not limited to, industrial plants, power plants, internal combustion engines, and incinerators, and may include any source that emits exhaust gas containing nitrogen oxides. The industrial plant may be a plant for manufacturing various materials or articles. The Industrial plant may be a semiconductor manufacturing plant, an oil refining plant, a polymer manufacturing plant, or the like. The power plant may include various power plants. The power plant may be a thermoelectric power plant, a combined heat and power plant, a nuclear power plant, or the like. The internal combustion engine may include various engines. The Internal combustion engine may be a diesel engine, a gasoline engine, a gas engine, or the like. The incinerator may be a waste incinerator. The emission source of exhaust gas may be a semiconductor manufacturing plant.

The disclosure will be described in more detail through the following examples and comparative examples. However, these examples are intended to illustrate the disclosure, and the scope of the disclosure is not limited thereto.

### Examples

Preparation of catalyst composition

Example 1: Ag₂O 0.5 wt % and CO₃O₄ 0.13 wt %, relative to the total weight of the catalyst composition

A_{g}NO₃, as a silver precursor, and Co(NO₃)₂·6H₂O, as a cobalt precursor, were added to 200 mL of distilled water according to the required catalyst composition, and stirred to dissolve, and then γ-Al₂O₃ was added and stirred to prepare a mixed solution.

The prepared mixed solution was heated to 80° C. and stirred for 12 hours to evaporate a solvent, thereby preparing a dry powder.

The prepared dry powder was further dried in an oven at 80° C. for 12 hours, and then sintered in an air atmosphere at 500° C. for 5 hours to prepare a catalyst composition.

The composition of the catalyst composition was 0.5 parts by weight of Ag₂O and 0.13 parts by weight of Co₃O₄ with respect to 100 parts by weight of Al₂O₃.

Example 2: Ag₂O 0.5 wt % and CO₃O₄ 0.66 wt %, relative to the total weight of the catalyst composition

A catalyst composition was prepared in the same manner as in Example 1, except that the composition of the catalyst composition was changed to 0.5 parts by weight of Ag₂O and 0.67 parts by weight of Co₃O₄ with respect to 100 parts by weight of Al₂O₃.

Example 3: Ag₂O 0.5 wt % and CO₃O₄ 1.31 wt %, relative to the total weight of the catalyst composition A catalyst composition was prepared in the same manner as in Example 1, except that the composition of the catalyst composition was changed to 0.5 parts by weight of Ag₂O and 1.33 parts by weight of Co₃O₄with respect to 100 parts by weight of Al₂O₃.

Comparative Example 1: Ag₂O 0.5 wt %

A catalyst composition was prepared in the same manner as in Example 1, except that the composition of the catalyst composition was changed to 0.5 parts by weight of Ag₂O with respect to 100 parts by weight of Al₂O₃, and Co₃O₄was omitted.

Comparative Example 2: CO₃O₄ 0.67 wt % A catalyst composition was prepared in the same manner as in Example 1, except that the composition of the catalyst composition was changed to 0.67 parts by weight of CO₃O₄with respect to 100 parts by weight of Al₂O₃, and Ag₂O was omitted.

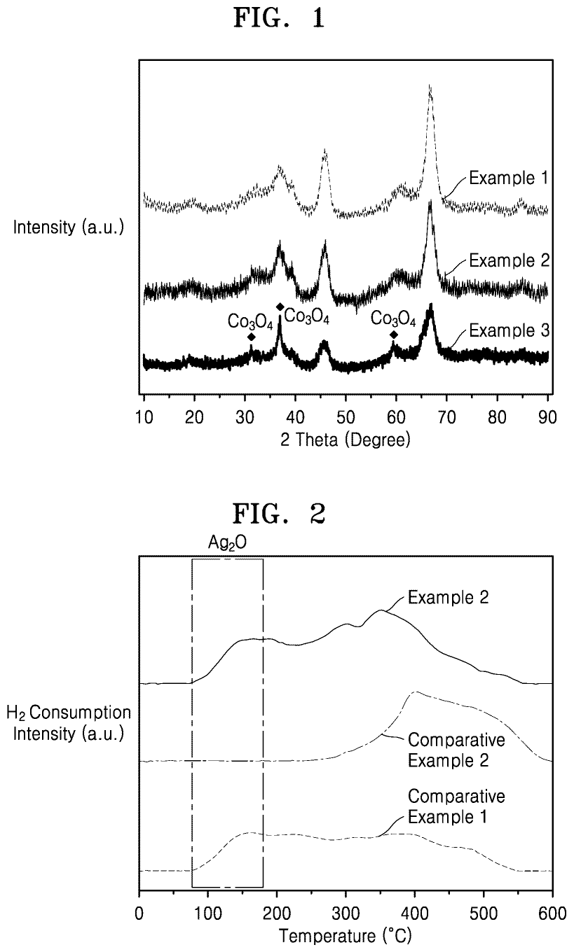

Evaluation Example 1: XRD spectrum analysis, confirmation of CO₃O₄XRD spectra of the catalyst compositions prepared in Examples 1 to 3 were measured, and the results thereof are shown in FIG. 1.

The XRD spectra were measured by using X'pert pro (Panalytical) with copper (Cu) Kα radiation (1.54 Å).

As shown in FIG. 1, characteristic peaks derived from CO₃O₄were observed in Example 3. Therefore, it was confirmed that the catalyst composition includes CO₃O₄as a second catalyst and that Co₃O₄is a crystalline metal oxide.

It was determined that characteristic peaks were not observed in Examples 1 and 2 due to the low content of CO₃O₄.

Evaluation Example 2: H₂-TPR analysis, confirmation of Ag₂O The catalyst compositions prepared in Example 2, Comparative Example 1, and Comparative Example 2 are measured by H₂-TPR (Temperature Programmed Reduction), and the results thereof are shown in FIG. 2.

H₂-TPR is a method to measure the content of hydrogen in the gas discharged while supplying hydrogen to a reactor containing a catalyst composition and increasing the temperature of the reactor according to a program, thereby measuring the content and temperature of hydrogen consumed for a reduction reaction within the reactor to evaluate the presence or absence of a specific component.

Referring to FIG. 2, in the catalyst compositions containing Ag₂O of Example 2 and Comparative Example 1, the content of hydrogen consumed increased, but in the catalyst composition containing only CO₃O₄ of Comparative Example 2, there was no change in the content of hydrogen consumed.

In Example 2 and Comparative Example 1, it was determined that hydrogen participated in the reduction reaction of Ag₂O and was consumed. Therefore, it was confirmed that the catalyst composition of Example 2 contained Ag₂O.

Evaluation Example 3: Evaluation of nitrogen oxide (NOₓ) conversion performance (I) The catalyst compositions prepared in Examples 1 to 3 and Comparative Example 1 were formed into pellet-shaped catalyst compositions.

The pellet-shaped catalyst compositions were put into a catalytic reactor.

The catalytic reactor is a tube-shaped reactor having a constant length, a pair of supports crossing the length of the tube were spaced apart from each other, and a pellet-shaped catalyst composition was placed between the pair of supports. The support is made of fiberglass non-woven fabric. A jacket-shaped furnace was placed outside the tube to control the temperature of the catalytic reactor.

Exhaust gas was supplied from the inlet to the outlet in the catalytic reactor at a flow rate of 100 L/hr.

A bubbler was connected to the catalytic reactor to supply isopropanol (IPA), as a reducing agent, to the exhaust gas upstream of the catalyst.

An in-situ FT-IR was connected to the catalytic reactor to monitor the catalytic reaction in real time.

The composition of the supplied exhaust gas is as follows: NO 100 ppm, IPA 133 ppm, oxygen 20%, carbon dioxide 9%, moisture (H₂O) 1.6% and a balance of nitrogen by volume. In the composition of the exhaust gas, IPA was supplied by the bubbler.

The velocity of the supplied exhaust gas is as follows: space velocity: 100,000 h-1, linear velocity: 0.7 m/s.

Catalytic performance was measured at 100° C. to 500° C.

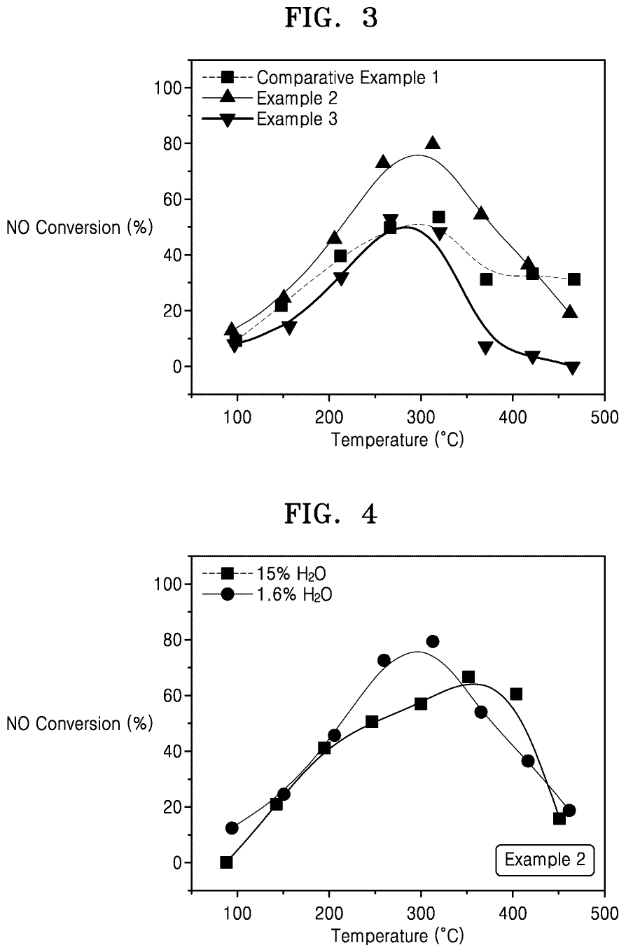

Some of the measurement results are shown in FIG. 3.

As shown in FIG. 3, the catalyst compositions of Examples 2 and 3 showed catalytic activity equivalent to or higher than that of the catalyst composition of Comparative Example 1 at 250° C. to 300° C., which is the main operating temperature range of IPA-SCR (isopropanol-selective catalytic reduction).

The catalyst composition of Example 2 showed a nitrogen oxide conversion rate of up to 84%.

The nitrogen oxide conversion rate is expressed as a percentage of the removed nitrogen oxides to the supplied nitrogen oxides when measuring the content of nitrogen oxides contained in untreated exhaust gas and the content of nitrogen oxides contained in exhaust gas treated by the catalyst composition.

Evaluation Example 4: Evaluation of nitrogen oxide (NOₓ) conversion performance (II) The catalyst composition prepared in Example 2 was formed into a pellet-shaped catalyst composition.

The catalyst composition prepared in Example 2 was evaluated in the same manner as in Evaluation Example 3, except that exhaust gas compositions having moisture contents of 1.6 % and 15 % were used, respectively.

The measurement results are shown in FIG. 4.

As shown in FIG. 4, the catalyst composition of Example 2 showed improved catalytic activity at 250° C. to 300° C., which is the main operating temperature range of IPA-SCR, as the moisture content decreased.

Therefore, it was confirmed that the catalyst composition of Example 2 showed improved catalytic activity in the exhaust gas having a low moisture content.

Evaluation Example 5: Evaluation of nitrogen oxide (NOₓ) conversion performance (III) The catalyst composition prepared in Comparative Example 1 was formed into a pellet-shaped catalyst composition.

The catalyst composition prepared in Comparative Example 1 was evaluated in the same manner as in Evaluation Example 3, except that exhaust gas compositions having moisture contents of 1.6 %, 5 %, and 10 % were used, respectively.

The measurement results are shown in FIG. 5.

As shown in FIG. 5, the catalyst composition of Comparative Example 1 showed decreased catalytic activity at 250° C. to 300° C., which is the main operating temperature range of IPA-SCR, as the moisture content decreased.

Therefore, it was confirmed that the catalyst composition of Comparative Example 1 showed decreased catalytic activity in the exhaust gas having a low moisture content. Evaluation Example 6: Evaluation of IPA adsorption performance according to moisture content The isopropanol (IPA) adsorption performance of the catalyst compositions prepared in Example 2 and Comparative Example 1 according to the presence or absence of moisture was evaluated by FT-IR.

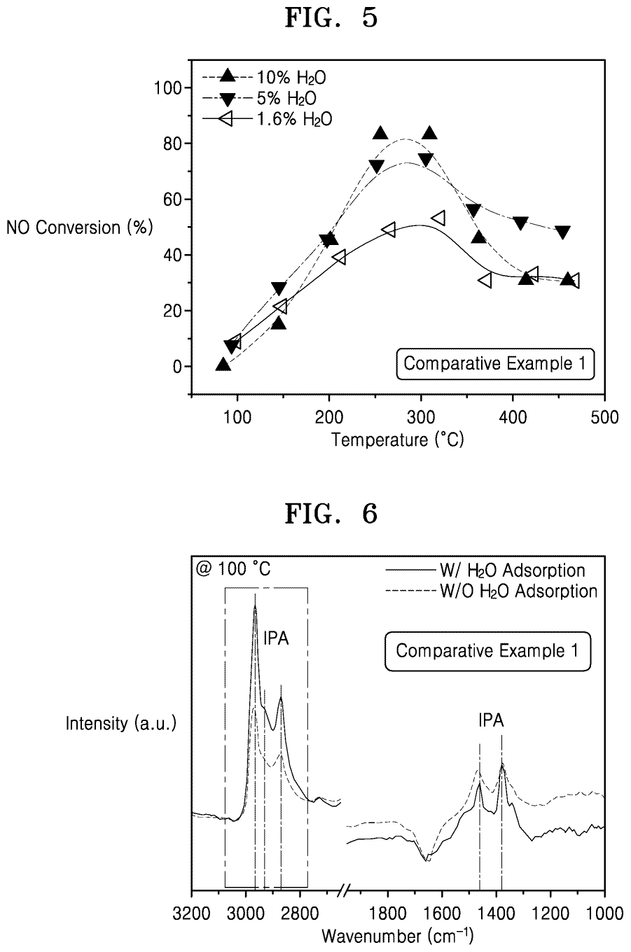

FIG. 6 is a graph illustrating the isopropanol (IPA) adsorption characteristics of the catalyst composition of Comparative Example 1 when moisture is supplied (w/o H₂O) and when moisture is not supplied (w/o H₂O).

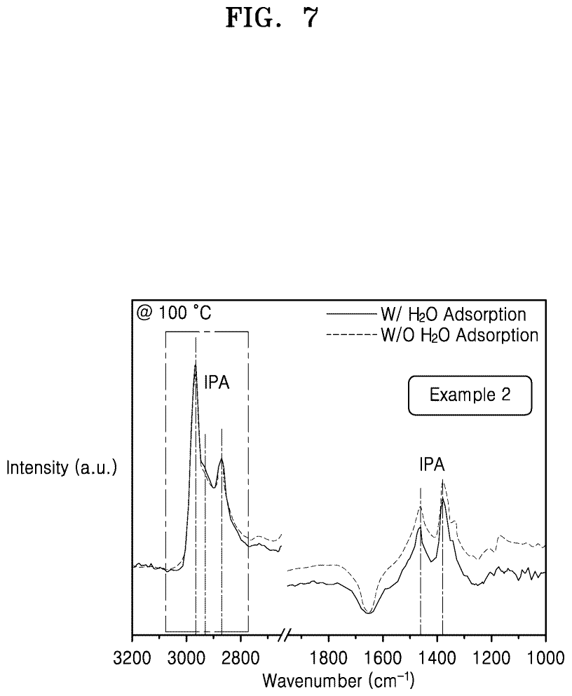

FIG. 7 is a graph illustrating the isopropanol (IPA) adsorption characteristics of the catalyst composition of Example 2 when moisture is supplied (w/o H₂O) and when moisture is not supplied (w/o H₂O).

As shown in FIG. 6, the peak intensity of the isopropanol (IPA) characteristic peaks in the catalyst composition of Comparative Example 1 was changed when moisture was supplied and when moisture was not supplied.

As shown in FIG. 7, the peak intensity of the isopropanol (IPA) characteristic peaks in the catalyst composition of Example 2 was not changed when moisture was supplied and when moisture was not supplied.

Therefore, in the catalyst composition of Comparative Example 1, it was confirmed that the adsorption of isopropanol (IPA) was activated by the adsorption of moisture on the catalyst composition.

It was determined that the catalyst composition of Comparative Example 1 promoted the adsorption and decomposition of isopropanol (IPA) by forming an active site, that is, a Bronsted acid site, by adsorbing moisture on the surface of Ag₂O.

In contrast, in the catalyst composition of Example 2, it was confirmed that the adsorption of isopropanol (IPA) was activated regardless of the adsorption of moisture on the catalyst composition.

It was determined that in the catalyst composition of Example 2, the second catalyst, Co₃O₄, provided a new active site, that is, a Bronsted acid site, for the adsorption and decomposition of isopropanol (IPA).

According to an aspect, a catalyst composition in an embodiment can provide a high nitrogen oxide removal efficiency at a relatively low operating temperature and a low moisture content.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

1. A selective catalytic reduction catalyst composition for treating exhaust gas containing nitrogen oxides, the catalyst composition comprising:
a first catalyst including a silver oxide represented by AgₘOₓ wherein m=1 or m=2 and 0.5≤x≤5, a silver metal represented by Ag, or a combination thereof;
a second catalyst including a metal oxide represented by MₐO_{b} wherein 1≤a≤5 and 1≤b≤5, a metal represented by M, or a combination thereof; and
a support,
wherein M is an element other than silver, belonging to Groups 3 to 14 and 16 of the Periodic Table of Elements.

2. The catalyst composition of claim 1,
wherein the first catalyst includes a plurality of silver oxides having different compositions from each other, and
the silver oxides include two or more of Ag₂O, AgO, Ag₂O₃, A_{g}O_{y} wherein 0.5<y<1, AgO_{z} wherein 1<z<1.5, AgO_{w} wherein 1.5<w≤5, or a combination thereof.

3. The catalyst composition of claim 2,
wherein a content of Ag₂O is highest among the silver oxides.

4. The catalyst composition of claim 1,
wherein the first catalyst includes a mixture of the silver metal and the silver oxide, a composite of the silver metal and the silver oxide, or a combination thereof,
the mixture of the silver metal and the silver oxide includes a mixture of Ag and A_{g}Oₓ wherein 0.5≤x≤5,
the composite of the silver metal and the silver oxide includes a core-shell composite, and
a core of the core-shell composite includes Ag, and a shell of the core-shell composite includes A_{g}Oₓ wherein 0.5≤x≤5.

5. The catalyst composition of claim 1,
wherein the metal oxide includes Co, Rh, Ir, Cr, Mo, W, Se, Te, Po, Ti, V, Mn, Fe, Ni, Cu, Zn, Zr, or a combination thereof.

6. The catalyst composition of claim 1, wherein the second catalyst includes Co_{c}O_{d} wherein 1≤c≤5, 1≤d≤5, Rh_{c}O_{d} wherein 1≤c≤5, 1≤d≤5, Ir_{c}O_{d} wherein 1≤c≤5, 1≤d≤5, Cr_{c}O_{d} wherein 1≤c≤5, 1≤d≤5, Mo_{c}O_{d} wherein 1≤c≤5, 1≤d≤5, W_{c}O_{d} wherein 1≤c≤5, 1≤d≤5, Se_{c}O_{d} wherein 1≤c≤5, 1≤d≤5, Te_{c}O_{d} wherein 1≤c≤5, 1≤d≤5, Po_{c}O_{d} wherein 1≤c≤5,1≤d≤5, Ti_{c}O_{d} wherein 1≤c≤5, 1≤d≤5, V_{c}O_{d} wherein 1≤c≤5, 1≤d≤5, Mn_{c}O_{d} wherein 1≤c≤5, 1≤d≤5, Fe_{c}O_{d} wherein 1≤c≤5, 1≤d≤5, Ni_{c}O_{d} wherein 1 ≤c≤5,1≤d≤5, Cu_{c}O_{d} wherein 1≤c≤5, 1≤d≤5, Zn_{c}O_{d} wherein 1≤c≤5, 1≤d≤5, Z_{c}O_{d} wherein 1≤c≤5, 1≤d≤5, or a combination thereof.

7. The catalyst composition of claim 1,
wherein the second catalyst includes a mixture of the metal and the metal oxide, a composite of the metal and the metal oxide, or a combination thereof,
the mixture of the metal and the metal oxide includes a mixture of M and MₐO_{b} wherein 1≤a≤5, 1≤b≤5,
the composite of the metal and the metal oxide includes a core-shell composite, and
a core of the core-shell composite includes M, and a shell of the core-shell composite includes MₐO_{b} wherein 1≤a≤5, 1≤b≤5.

8. The catalyst composition of claim 1,
wherein the first catalyst includes A_{g}Oₓ wherein 0.5≤x≤5, and the second catalyst includes Co_{c}O_{d} wherein 1≤c≤5, and 1≤d≤5.

9. The catalyst composition of claim 1,
wherein the first catalyst includes Ag₂O, AgO, Ag₂O₃, A_{g}O_{y} wherein 0.5≤y≤1, A_{g}O_{y} wherein 1≤y≤1.5, A_{g}O_{y} wherein 1.5≤y≤5, or a combination thereof, and the second catalyst includes CoO, CO₂O₃, CO₃O₄, CoO₂, CoO₃, or a combination thereof.

10. The catalyst composition of claim 1,
wherein the support includes a carbon-containing support, a metal oxide-containing support, or a combination thereof,
the carbon-containing support includes carbon black, active carbon, carbon nanotubes, or a combination thereof, and
the metal oxide-containing support includes alumina, titania, silica, zirconia, silica-alumina, aluminosilicate, alumina-zirconia, alumina-chromia, alumina-ceria, or a combination thereof.

11. The catalyst composition of claim 1,
wherein a content of the first catalyst is about 0.05 weight percent to about 30 weight percent with respect to a total weight of the catalyst composition, and
a content of the second catalyst is about 0.05 weight percent to about 30 weight percent with respect to a total weight of the catalyst composition.

12. The catalyst composition of claim 1,
wherein a weight ratio of the first catalyst and the second catalyst is 1: more than 0 and up to 1:10.

13. The catalyst composition of claim 1,
wherein the first catalyst has a particle diameter of 20 micrometers or less, and the second catalyst has a particle diameter of 20 micrometers or less, and
a ratio of the particle diameter of the first catalyst and the particle diameter of the second catalyst is about 1:0.01 to about 1:10, and
optionally, the particle diameter of the first catalyst is larger than the particle diameter of the second catalyst.

14. The catalyst composition of claim 1,
wherein the exhaust gas contains moisture, and
a content of the moisture is 50 volume percent or less with respect to a total volume of the exhaust gas.

15. A method of treating exhaust gas containing nitrogen oxides, the method comprising:
contacting the exhaust gas with an alcoholic reducing agent in the presence of the catalyst composition according to claim 1.

16. The method of claim 15,
wherein, in the contacting of the exhaust gas with the alcoholic reducing agent,
a mixing volume ratio of the nitrogen oxides and the alcoholic reducing agent is about 1:1 to about 1:10.

17. The method of claim 15,
wherein the exhaust gas contains moisture,
a content of the moisture is 50 volume percent or less with respect to a total volume of the exhaust gas, and
the contacting is performed at about 150 ° C. to about 400 ° C.

18. A system for treating exhaust gas containing nitrogen oxides, the system comprising:
a catalyst article located downstream from an emission source emitting the exhaust gas, in fluid communication with the emission source, wherein the catalyst article includes the catalyst composition of claim 1.

19. The system of claim 18, further comprising
an alcohol injector located upstream of the catalyst article and arranged in fluid communication with the catalyst article.

20. The system of claim 18, further comprising:
a catalyzed soot filter located upstream or downstream of the catalyst article and arranged in fluid communication with the catalyst article; or
a diesel oxidation catalyst located upstream or downstream of the catalyst article and arranged in fluid communication with the catalyst article,
wherein the emission source is an industrial plant, a power plant, an internal combustion engine, or an incinerator.
